(19) United States
(12) Patent Application Publication
(10) Pub. No.: US 2009/0138331 A1
(43) Pub. Date: May 28, 2009

(54) System and Method for Sponsorship Sourcing System

(76) Inventor: Charles D. Brown, Woodinville, WA (US)

Correspondence Address: PATRICK M DWYER PC, 14419 GREENWOOD AVENUE N, #322, SEATTLE, WA, 98133-6865, US

(21) Appl. No.: 12/212,553

(22) Filed: Sep. 17, 2008

Related U.S. Application Data
(63) Continuation of application No. 11/582,611, filed on Oct. 17, 2006.
(60) Provisional application No. 60/727,521, filed on Oct. 17, 2005.
(60) Provisional application No. 60/994,339, filed on Sep. 18, 2007.

(51) Int. Cl. G06Q 30/00; G06Q 10/00; G06F 17/30; G06Q 50/00

(52) U.S. Cl. 705/10; 705/80; 707/104.1; 707/E17.018; 707/E17.044

(57) ABSTRACT

A system and method are disclosed for automating the interaction between the producers of festivals and events and potential festival and event sponsors for the purpose of selling, sourcing and exchanging sponsorship assets. The system receives data input from producers regarding sponsorship assets and from potential event sponsors about their marketing campaign requirements. Data is combined with data from other sources and programmatically integrated, then programmatically analyzed, matched and optimized to return event sponsorship assets which meet sponsors' requirements and packages and campaigns are created. The packages are then proposed either by the sponsors to the producers or vice versa. Throughout the negotiation and purchase process, the system allows event producers to track multiple sales through the sales process and sponsors to track assets proposed and purchased from multiple events for a campaign. The system provides a communication format for negotiations and programmatically creates a sponsorship contract.

This continuation in part application claims priority to U.S. patent application Ser. No. 11/582,611 filed Oct. 17, 2006 (which claimed priority to U.S. provisional application 60/727,521 filed Oct. 17, 2005), and to U.S. provisional application 60/994,339 filed Sep. 18, 2007).

### TECHNICAL FIELD

The invention relates to systems and methods for sponsorship sourcing; more particularly, it relates to systems and methods for automating the interaction between the producers of events and potential sponsors of the events for the purpose of selling, sourcing and exchanging sponsorship assets.

### BACKGROUND OF THE INVENTION

Producers of festivals and community events commonly negotiate sponsorship with sellers of goods and services or their agents in return for advertising opportunities unique to the event, such as identifying sponsors in radio and television spots, on banners, on the printed or online schedule, in the event title and by including merchandise in gift bags. Such advertising opportunities are considered sponsorship “assets” and each asset will have a marketing effect. Some marketing effects are, for example, numbers of consumers reached within specific demographics, numbers of sales leads generated, items sampled and unit sales.

Generally, sponsors are businesses who seek to promote themselves, their products, services, causes and ideas to consumers, other businesses, employees, prospective employees and communities by sponsoring assets made available by events. Marketers expend significant time developing sponsorship programs because events are numerous, they are difficult to find, they have broad arrays of sponsorship assets, and it is difficult to organize the assets into packages without awareness of sponsor requirements. Consequently, the mix of assets vary greatly from event to event, making it difficult for sponsors to implement programs that are consistent across events.

Accordingly, event producers have a difficult time attracting sponsors because the event producers do not understand the sponsor requirements and do not meet the sponsors' needs. The effort required by sponsors to organize disparate event sponsorship packages often requires more effort than a sponsor can justify expending.

Moreover, events do not have a system and process that allows them to fully understand the demographic profile of their attendees. This lack of understanding prohibits events from providing information to sponsors that allow the sponsor to determine to the percentage of attendees within the sponsor's target audience. The lack of demographic information therefore makes it difficult for the sponsor to calculate the return on their investment.

In addition, events do not have methods and processes that allow them to check the number of impressions generated for the sponsorship assets and packages that the event organizers provide to sponsors. The lack of information about the number of impressions generated by the sponsorship assets when bundled or placed into packages further limits the ability of the sponsor to calculate the return on the sponsor's investment.

Currently, if event producers and event sponsors or their agents attempt to make their own assessments of the value of sponsorship assets, they do so without centralized data. Producers and sponsors have no way to know the true marketing effects or value of such assets. Producers are often unaware of sponsors requirements and needs. If a sponsor wishes to coordinate a marketing campaign through several events, targeting a specific geographic area or customer demographic, they must perform their own cost/benefit analysis identifying assets to be purchased often without adequate demographic information available.

At some point, either event producers contact sponsors or vice versa with proposals for the purchase of sponsorship assets and negotiations proceed through the normal channels of communication. Sponsors must continually adjust their campaign proposals as assets are purchased or lost, particularly difficult during multiple negotiations over time. Likewise, event producers must track their sales of sponsorship assets through lengthy negotiation processes.

At the point when sponsors have identified a sponsorship package they want and enter the process of negotiating to purchase the sponsorship package they expend excessive energy negotiating the specific assets, terms and in-kind contribution for the sponsorship package and must repeat the process for each sponsorship package.

The conditions above demonstrate the need for a system and method that automates the interaction between event producers and sponsors. More particularly, a need exists for an automated system that addresses the needs for matching event assets with sponsor requirements, identifying events that meet the sponsors geographic, demographic, psycho-graphic and budgetary requirements, determining the impressions available with a given set of sponsorship assets and packages, and facilitating efficient contract negotiations.

### DISCLOSURE OF THE INVENTION

The disclosed system and method provides an automated system that matches event assets with sponsor requirements, identifies events that meet the sponsors' geographic, demographic, psycho-graphic and budgetary requirements, determines the impressions and consumer reach available with a given set of sponsorship assets and packages, and facilitates efficient contract negotiations.

In addition, the disclosed system and method provides an automated system that allows sponsors to rank potential assets and produces television program recommendations. Copending U.S. patent application Ser. No. 10/993,921 entitled Process for Media Integration is herewith incorporated by reference as if fully set forth herein.

The disclosed system and method also provides means for both producers and sponsors to track multiple negotiations for continually changing sponsorship packages, submit proposals to the other party and creates contract language from the negotiation data. For event producers the system tracks and reports the sales process on each asset package for each sponsor with whom they are negotiating. For event sponsors, the system tracks and reports the assets proposed and purchased, the type of assets that are proposed and purchased, and the total cost distribution for multiple events within a campaign.

The system and method disclosed automates the interaction between event producers and sponsors. At least one computer hosts a sponsorship sourcing application programmed to perform in the manner described below, and input and output means are provided to festival and event producers and to potential sponsors. The computer also advantageously contains computer readable storage media, having a database or system of databases. The system and method disclosed are advantageously suited for use over a public distributed network, such as the Internet due to its widespread availability. In this case, a computer server or system of servers runs the sponsorship sourcing application. An advantageous means for input and output to the system is a website also hosted on the server or system of servers.

When used in conjunction with “network”, the term “public” is intended to imply that the user's access to the network is not controlled by or limited to a particular business entity or group of business entities. Likewise, the term “distributed” implies that processing capabilities and services are advantageously spread out among different nodes of the network with different nodes providing different services, as opposed to being centralized within a single host, server or LAN. In general, however, the system and method can be used on any type of distributed network over which online services are provided by service providers to end users, including both public and private, and hybrid public-private networks. In some embodiments, a single computer running a sponsorship sourcing application as disclosed herein serves to automate sponsorship interactions between event producers and sponsors.

As discussed in the Background section of this disclosure, producers of festivals and community events negotiate sponsorship with sellers of goods and services or their agents in return for advertising opportunities unique to the event. Advertising opportunities at festivals and events are referred to herein as sponsorship “assets”. Several examples of sponsorship assets are identifying sponsors in radio and television spots, on banners, in the printed or online schedule, in the event title, in announcements made from stages, through electronic images presented from various screens, providing sponsors booths for merchandise sales or customer service and including sponsor merchandise in gift bags.

One advantage of the disclosed system and method is that it optimally provides a centralized data source for event geographic, demographic, psycho-graphic and asset cost information for multiple festivals and events. Data is gathered from multiple public and private sources and programmatically integrated.

One source is by input from event producers who are seeking sponsorship for the event. Examples of data stored for each event are such basic data as the event name, dates, location, frequency, producer contact information, and admission and parking prices. Data more specific to sponsorship interests are: 1) related events as in the case of a series, 2) attendee geographic data, such as the neighborhood or radius within which attendees reside, 3) attendee demographic data, such as gender, family income, individual income, age, race, attained education level, educational enrollment, marital status, family size and ancestry, 4) attendee psycho-graphic data, such as music, sports and dance preferences, alcohol consumption levels, political alignments and preferences for physical activities.

In addition, producers provide information on each asset available for purchase, such as asset type, venue, activation dates, physical size, reach percent what percent of the attendance receives an impression from that asset and cost. Advantageously, producers are provided a systematized format for entering asset information that is geared to meeting the informational needs of sponsors.

In addition to the data input by producers, advantageously, sponsors provide data from their previous interaction with the event and the disclosed system. Sponsors may input data specifically for this purpose or as part of another process within the system. For example, in one embodiment, the system and method provide input means for sponsors to measure and analyze marketing return on their asset purchases. As part of the data recording and report creation during the analysis processes, data is recorded into the system databases which is then available for integration with existing data for the event. Such data may be demographic data recorded by live contact with attendees at booths or elsewhere, sales figures, leads generated, numbers of samples or demonstrations provided and so forth.

Outside sources are also mined for data, such as census bureaus, tax entities, digital mapping sources and attendee survey forms. Data from these sources may be input by manual means or various digital data gathering means such as spiders, web crawlers, data miners and other such means now known or later developed.

Once data has been gathered, the sponsorship sourcing application analyzes sponsorship assets according to their probable marketing effects. In one embodiment, this is accomplished through an impression calculation engine which is part of the application. The engine takes geographic, demographic and psycho-graphic data and, using well known and preselected algorithms, processes the above data with asset related data to produce marketing projections, such as consumer reach, numbers of impressions and impression frequency figures, for individual assets for one skilled in the art of advertising and marketing, appropriate such algorithms are well known and will readily occur.

For example, the impression calculation engine can take the data that the Metropolis Summerfest festival's attendance is 250,000, that 25,000 of those attendees have an educational level of advanced college degree, that 5,000 of those attendees have an income level of $150,000 or greater, and that 20% of the festival attendees will visit the beer garden, and apply a selected algorithm to inform it's beer garden sponsors that an advertisement shown on a screen placed in the beer garden will reach 7,000 potential customers daily who have an education level of advanced college degree and an income level of $150,000 or greater. Similarly, the disclosed impression calculation engine utilizes algorithms developed for each sponsorship asset to produce marketing projections.

The sponsorship sourcing application provides a means for festival and event producers to combine the assets of an event into sponsorship packages. Producers select titles for use in identifying packages and optionally the system suggests packages based upon common packaging principles or previous packages created for the event in years past. For example, common packages are for a title sponsor, a presenting sponsor or a basic sponsor. Smaller sponsorships are often available for special areas, such as a beer garden, music venue or dance hall. Other types of sponsorship packages may accompany the purchase of a booth or kiosk of varying sizes. Advantageously, as the producer selects assets for inclusion into a package, the system displays the previously entered price of the asset and the total of all the individual asset costs. This allows the producer to select a discounted cost for the package. Alternately, the program may use a percent discount entered by the producer to programmatically produce a package cost. It is advantageous to display for the producer the total number of assets and packages they are offering for their event, the total value for each package type and asset inventory data, such as the total inventory value for the event.

The disclosed system and method also provide means for sponsors to input sponsorship program requirements. Sponsors input the desired parameters for a sponsorship program that might span several festivals or only one. Optimally, general data is collected for a program such as program name, manager, client information if the program is for a client of a marketing company, the program start and end dates and target days on the ground.

Optimally, sponsors select and define customer profiles and demographic categories for the program, such as gender, family income, individual income, age, race, education attainment, education enrollment, marital status, family size and ancestry. Sponsors also input geographic requirements, such as entering that a program only include sponsorship of events in the Northeast or events in major U.S. cities. Optimally, as sponsors define a program, census information can be integrated to display for the sponsor the total population that would be available for their selections. For example, if a sponsor selected an age demographic of over 65 and a geographic requirement of Washington state, the system would display the number of people over 65 in Washington state. In addition, sponsors optionally select lifestyle demographics and the class or classes of events they desire to sponsor, such as art, children, food, heritage/historical, holiday, music and sports.

Optimally, sponsors enter the marketing activities they desire to be performed, such as advertising, branding, corporate relations, personal selling, public relations, market research, sales promotion and cause overlay.

Advantageously, sponsors also enter their marketing requirements, such as which asset types they desire to purchase. Examples of asset types are event title banners, event title radio and television advertising, T-shirts on the event staff, periodic audio announcements and any other advertising opportunity presented by a festival or event. At this point in the input process, sponsors generally do not have specific events in mind. Advantageously, they are provided a systematized format for entering desired sponsorship requirements without the need for knowledge of specific events.

Optionally, sponsors also rank their asset type requirements. For example, a scale of 1 to 10 may be used with 1 signifying a “must have” asset and 10 signifying “not necessary”. For example, if a beer manufacturer must have a beer garden sponsorship, they would rank it “1”. If the same sponsor did not think that being an event's title sponsor was a good return on the investment, they would rank it “10”.

Advantageously, sponsors also enter data on their budget requirements. Optionally, sponsors enter a total program budget and individual budgets for such items as sponsorship rights, activation and product demonstrations. More detailed budgeting items are also optionally included, such as logistical items, travel, gas, lodging and other personnel costs.

Additionally, sponsors enter data for program goals, such as desired numbers for impression counts, items sampled, surveys collected, leads generated, unit sales, person-to-person interactions and customers serviced. Optionally, monetary amounts are entered for such returns as unit sales and customer revenues.

Advantageously, the sponsorship sourcing application generates campaigns spanning multiple events. Optimally the system allows sponsors to enter specifications for the combination of events desired. Sponsors enter criteria such as the optimum number of events, whether the events are linked by class type, whether the sponsor requires the title sponsorship position for each event and so forth.

Through the sponsorship sourcing application, the disclosed system and method automates the process of matching events and event assets with sponsor requirements. Data for all the festivals and events within the system, which has been augmented and combined to produce maximum calculated data such as impression data from the impression calculation engine, is parsed and compared with the data entered by sponsors seeking sponsorship opportunities. The resulting returns are then processed through optimization engines which return specific event and asset recommendations by optimizing selected asset characteristics, such as impression frequency, number of impressions, and the like, to achieve impression goals. Recommendations are returned to producers as a sponsorship opportunity and to sponsors as program recommendations, so that either can begin the proposal and negotiation process.

For example, one embodiment of the disclosed system and method returns events whose dates fall within the date intervals entered by potential sponsors for sponsorship programs, returning a reduced body of events for further processing. Event locations are matched with geographical requirements; event lifestyle or class definitions are matched with lifestyle requirements; and event demographics are matched with demographic requirements. In addition, a marketing program asset mapping engine locates the assets within the events that match the sponsor's requirements for marketing activities and asset types. A demographic reach optimization engine uses the events' geographic, lifestyle and demographic data to determine the events and assets that will produce the greatest number of impressions within the sponsor's selected program impression goals. Preferably, sponsors' budgetary requirements are also used in the optimization process.

The impression calculation process engine further combines assets, using selected algorithms as discussed above, to produce marketing projections for packages of assets. One skilled in the art will appreciate that, in the case of marketing impressions, the sum of the whole does not equal the sum of the individual parts.

For example, the producers of Family Fun Day have entered their event and asset data, and created a title sponsorship package. Meanwhile, ToyAmerica Corporation has entered data for sponsorship requirements. They are looking to obtain title sponsorship rights in a children's festival in the Midwest. The system matches and optimizes event recommendations for ToyAmerica, and Family Fun Day is one of 4 events which has the potential to return the marketing activities and impression goals ToyAmerica requires. Family Fun Day occurs within the data interval required, is located in Minneapolis, has the right lifestyle or event class since it includes children's activities, has the title sponsorship assets available at the right cost. The demographic optimization engine returns numbers within ToyAmerica's target goals. The event recommendation is returned to the marketing director for ToyAmerica Corporation as a program recommendation. It is also returned to the producer of Family Fun Day as a sponsorship opportunity.

Advantageously, both the sponsorship opportunity and the program recommendation are returned with all the data which is calculated from the impression calculation engine and demographic reach optimization engine. When a producer is making a proposal, they can present specific reach projections. For example, the producer of Family Fun Day would be able to point out that the estimated number of samples tested by children under age 11 exceeds ToyAmerica's target goal by 20%. Likewise, when a sponsor is comparing several proposed events, they would be able to view and compare specific impression and sales numbers. For example, ToyAmerica could see that Family Fun Day provides 35,000 attendees within their target household income demographic, which is 53.4% of their total goal for that demographic.

In one embodiment, the system and method provide a broadcast television program barter system. For sponsors that require a branded entertainment television program within a sponsorship package, the system matches the sponsor to events that provide such an asset within their sponsorship assets or packages.

Advantageously, both the producer and potential sponsor can customize the sponsorship opportunity and program recommendation respectively, adjusting quantities and pricing. Either the producer or the potential sponsor can begin the proposal and negotiation process. During the negotiations, either party can still make changes to the proposals. Sponsors can advantageously submit “change requests” to the producers, while producers submit “proposed substitutions” to the event producers. During negotiations, the system preferably tracks and reports the negotiation process. For example, the system reports the value of new assets added, the start price of the package and the difference between the start price and the current price.

During sponsorship rights negotiations, the system's reporting and analysis features allow sponsors to track projected marketing effects for the total number of sponsorship assets, in each package and within the entire campaign, throughout multiple negotiations. As a sponsor adds and subtracts sponsorship assets from a package, an impression calculation engine returns the number of customer impressions that will be made and the number of anticipated sales leads generated by the package. For example, a sponsor can instantly see that if they eliminate their name from the banner over the festival entrance, which will cost them $15,000, they will lose 150,000 impressions and fall well below their goal. Because of this they choose to eliminate 3 advertisements on a screen in the stadium, each costing $5000, which will only result in 30,000 lost impressions for the campaign. Advantageously, a summary for the entire program is continuously generated which allows sponsors to track the status of their negotiation progress toward achieving their marketing activity and impression goals. Optimally, they also track their costs for each event and the campaign as a whole.

In addition, producers are optimally provided an event sponsorship asset and package contract negotiation system for tracking sponsorship asset sales through all stages of the sales process. Advantageously, a sales opportunity input and reporting system includes data such as the sponsor's name, the opportunity name, the opportunity status, the event response and the dates of the status and response. As packages are adjusted and revised throughout the negotiations, details of which assets have been purchased and at what costs are reported to both producers and sponsors in accessible formats. Reports clarify cost/sales totals and allow tracking of resources between the various asset types, and tracking of the marketing effect statistics of the campaign as negotiations progress.

In one embodiment, the system provides an instantaneous communication format for efficient contract negotiations over time and between multiple transactions. Producers and sponsors have access to the current proposal and can request changes or approve the proposals at any time. In addition, contract language is generated automatically and made available to each party as negotiations proceed, making contracts available to be accepted upon completion of negotiations with no delay.

The above disclosed system and method automates the interaction between the producers of festivals and events and potential festival and event sponsors for the purpose of selling, sourcing and exchanging sponsorship assets. The system receives data input from producers regarding sponsorship assets and from potential event sponsors about their marketing campaign requirements. Data is combined with data from other sources and programmatically integrated, then programmatically analyzed, matched and optimized to return event sponsorship assets which meet sponsors' requirements and packages and campaigns are created. The packages are then proposed either by the sponsors to the producers or vice versa. Throughout the negotiation and purchase process, the system allows event producers to track multiple sales through the sales process and sponsors to track assets proposed and purchased from multiple events for a campaign. The system provides a communication format for negotiations and programmatically creates a sponsorship contract.

A system for sponsorship sourcing of events is disclosed which includes at least one computer and a means for input to and output from computer readable storage media, such as a database or system of databases. A sponsorship sourcing application runs on the computer. The application is operatively configured to store data input from an event producer and use the event producer's data input to programmatically create and store event asset data, such as asset types, asset descriptions, asset prices, asset locations, quantities of assets, asset dimensions, asset package elements and asset package prices.

In addition to data from an event producer, data is input from an event sponsor and the data is used to programmatically create and store sponsorship requirement data, such as customer profiles, demographics, geography, lifestyle, budget, marketing activity, asset types, asset ranking, number of impressions, consumer reach numbers, impression frequency and package requirements. All of the data input to the system is integrated, analyzed and used to match event asset data to sponsorship requirement data to programmatically create a sponsorship program.

Additionally, data is obtained stored from data sources such as census bureaus, geographic mapping sources, tax bureaus and city planning offices. This data is also analyzed and combined to programmatically create and store data pertinent to event sponsorship.

The sponsorship sourcing application also includes a demographic reach optimization engine which produces event recommendations, a television program barter engine which produces television program recommendations and an asset mapping engine which produces sponsorship asset recommendations.

The sponsorship sourcing application also includes an impression calculation engine which produces, from market research and raw impression estimate data for each proposed asset, predictions such as numbers of impressions, durations of impressions, consumer reach figures, impression frequency figures, cost per impression and return on investment figures.

The sponsorship sourcing application also stores negotiation data input from producers and sponsors, such as asset assignments to sponsorship packages, unit quantities and pricing, sponsor change requests, producer proposed substitutions, proposals, proposal acceptance and proposal rejection. The application also analyzes the negotiation data, calculates and stores the negotiation calculations, and outputs the negotiation data to producers and sponsors. The sponsorship sourcing application also tracks negotiation input and creates reports of negotiation progress, such as reports to event producers of the sales process on each package for each sponsor and reports to sponsors of assets proposed, assets purchased, asset type and total cost distribution.

The sponsorship sourcing application also creates sponsorship contract documents during the negotiation process, with language that is correlated to each possible respective selection in the negotiation process, the contract documents then being available to sponsors and producers at the close of negotiations.

An alternate system for sponsorship sourcing of events is also disclosed which runs over a distributed network. The system includes one or more computers operating as a server on a distributed network. The server also hosts a website. At least one computer operates as a client to the server and runs a browser application for accessing the website. The system includes a means for input to and output from computer readable storage media such as a database or databases which reside on the one or more server computers. The server or a combination of servers runs a sponsorship sourcing application which stores data input from an event producer, uses the event producer's data input to programmatically create and store event asset data, stores data input from an event sponsor, uses the event sponsor's data input to programmatically create and store sponsorship requirement data, and matches event asset data to sponsorship requirement data to programmatically create a sponsorship program. The sponsorship sourcing application also produces event recommendations through a demographic reach optimization engine, produces television program recommendations through a television program barter engine, produces sponsorship asset recommendations through an asset mapping engine, produces predictions such as numbers of impressions, durations of impressions, consumer reach figures, impression frequency figures, cost per impression and return on investment figures through an impression calculation engine, stores negotiation data input from producers and sponsors, analyzes negotiation data, calculates and stores negotiation calculations, outputs negotiation data to producers and sponsors, tracks negotiation input and creates reports of negotiation progress, and creates sponsorship contract documents during the negotiation process which are available at the close of negotiations.

### BRIEF DESCRIPTION OF THE DRAWINGS

FIG. 1 is a schematic diagram of one embodiment of a Sponsorship Sourcing System.

FIG. 2 is a schematic diagram of a Program Learning Feedback Loop model within a Sponsorship Sourcing System.

FIG. 3 is a block diagram of three processes contributing to a Sponsorship Sourcing System.

FIG. 4 is a block diagram of three processes contributing to a Sponsorship Provisioning Subsystem.

FIG. 5 is a block diagram of three processes contributing to a Sponsorship Program Development Subsystem.

FIG. 6 is a block diagram of processes contributing to a Sponsorship Service Subsystem.

FIG. 7 is a block diagram of processes contributing to an Event Demographic, Lifestyle and Geographic Profile System.

FIG. 8 is a block diagram of processes contributing an Event Geographic Profile System.

FIG. 9 is a block diagram of processes contributing an Event Lifestyle Profile System.

FIG. 10 is a block diagram of processes contributing to an Event Demographic Profile System.

FIG. 11 is a block diagram of sub-processes contributing to an Event Sponsorship Asset and Package Development Process.

FIG. 12 is a block diagram of processes contributing to an Event Sponsorship Proposal Creation and Negotiation System.

FIG. 13 is a block diagram of processes contributing to a Sponsor Program Requirements Specification System.

FIG. 14 is a block diagram of processes contributing to a Sponsor Sponsorship Asset Requirements Development and Submission System.

FIG. 15 is a block diagram of processes contributing to a Sponsor Package Evaluation, Selection, and Negotiation System.

FIG. 16 is a block diagram of elements within an Event Geography Matching Process.

FIG. 17 is a block diagram of elements within an Event Lifestyle Matching Process.

FIG. 18 is a block diagram of elements within an Event Demographic Matching Process.

FIG. 19 is a block diagram of elements within a Demographic Reach Optimization Process.

FIG. 20 is a block diagram of elements of a Broadcast Barter Process.

FIG. 21 is a block diagram of elements of an Asset Mapping Process.

FIG. 22 is a block diagram of elements of an Impression Calculation Process.

FIG. 23 is a block diagram of elements of a Sponsorship Asset Recommendation Process.

FIG. 24 is a block diagram of elements of a Sponsorship Asset Negotiation Process.

FIG. 25 is a block diagram of elements of a Sponsorship Contract Negotiation Process.

FIG. 26 is a block diagram of elements of a Requirements Broadcast Process.

FIG. 27 is a flowchart of a Sponsorship Sourcing State Machine.

FIG. 28 is a screenshot of an Event Profile Input Screen.

FIG. 29 is a screenshot of a Demographic Profile Input Screen.

FIG. 30 is a screenshot of a Sponsorship Asset Type Selection Screen.

FIG. 31 is a screenshot of a Sponsorship Asset Input Screen.

FIG. 32 is a screenshot of a Sponsorship Package Creation Screen.

FIG. 33 is a screenshot of a Sponsorship Inventory Analysis Screen.

FIG. 34 is a screenshot of a Sponsorship Opportunity Development Screen.

FIG. 35 is a screenshot of a Sponsorship Proposal Development Screen.

FIG. 36 is a screenshot of a Sponsorship Asset Negotiation Screen.

FIG. 37 is a screenshot of a Sponsorship Contract Negotiation Screen.

FIG. 38 is a screenshot of a Sponsor Sponsorship Program Screen.

FIG. 39 is a screenshot of a Sponsor Geographic Requirements Input Screen.

FIG. 40 is a screenshot of a Sponsor Event Lifestyle Requirements Input Screen.

FIG. 41 is a screenshot of a Sponsor Demographic Category Requirements Input Screen.

FIG. 42 is a screenshot of a Sponsor Demographic Detail Requirements Input Screen.

FIG. 43 is a screenshot of a Sponsor Marketing Requirements Specification Input Screen.

FIG. 44 is a screenshot of a Sponsor Recommendation Summary Review Screen.

FIG. 45 is a screenshot of a Sponsor Recommendation Detailed Event Review Screen.

FIG. 46 is a screenshot of a Sponsor Sponsorship Impression Class Benefit Screen.

FIG. 47 is a block diagram of processes contributing to a Sponsorship Program Modeling and Analysis Process.

FIG. 48 is a block diagram of an Integrated Sponsorship Service System.

FIG. 49 is a block diagram of a Sponsor Program Return On Investment Modeling and Measurement System.

FIG. 50 is a block diagram of a Sponsorship Program Modeling and Analysis User Interface.

### BEST MODE OF CARRYING OUT THE INVENTION

Turning now to the drawings, the invention will be described in a preferred embodiment by reference to the numerals of the drawing figures wherein like numbers indicate like parts.

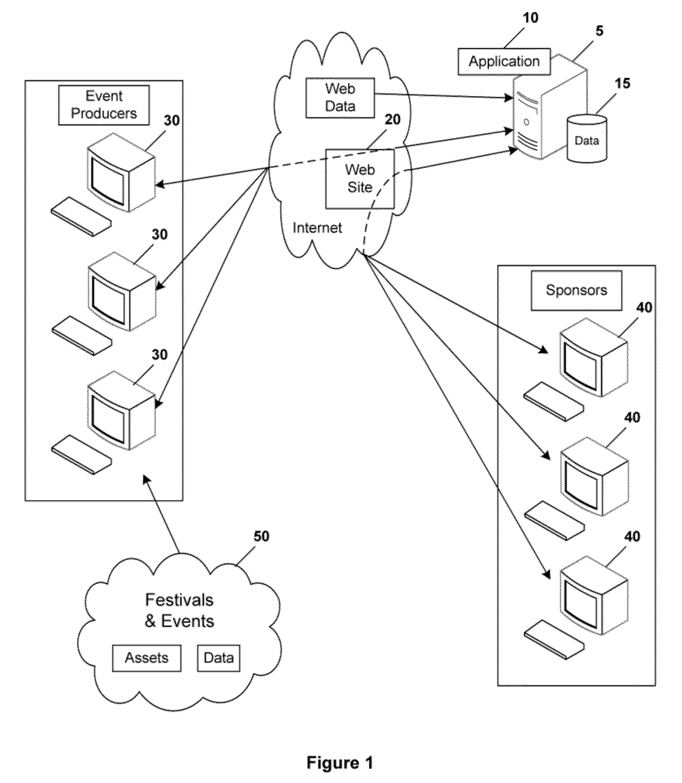

FIG. 1 is a schematic diagram of one embodiment of a Sponsorship Sourcing System. Server 5 hosts a sponsorship sourcing application 10 operably connected to a database 15. The server also hosts a web site 20 which provides input and output means to festival and event producers and potential sponsors through client computers' 30 browser applications, used by the event producers, and client computers' 40 browser applications, used by event sponsors. Event producers gather data and develop assets from festivals and events 50 and store the data in database 15 through input through web site 20. Data is also stored by sponsors. Preferably, sponsors contribute both previous events data and input current sponsorship requirements data. In addition, data is gathered from the Internet via spiders, web crawlers, data miners and other such means or input directly to server 5. Sponsorship sourcing application 10 analyzes and integrates the data, matches the events asset data to sponsorship requirements data as described in part above in the Disclosure section and optimizes sponsorship asset packages either for sponsor or for event producer. Packages are returned to the event producers as program recommendations and to potential sponsors as sponsorship opportunities via website 20 and client computers' 30 and 40 browsers.

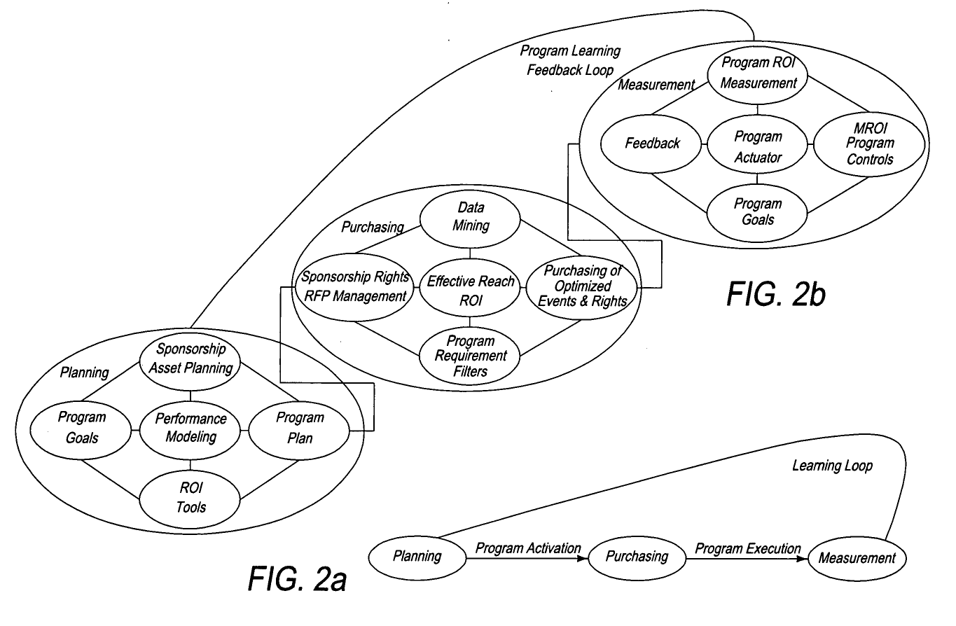

FIG. 2 is a schematic illustration of a program learning feedback loop that is enabled uniquely by the disclosed process. FIG. 2a is a summary figure illustrating the broad aspects of the learning loop; namely, planning, followed by activation of selected programs, followed by purchasing of such programs, followed by execution of activated and purchased programs, followed by measurement of various results of those programs, all feeding back into planning again for the next round of sponsorship purchases.

FIG. 2b goes into more detail for each of the planning, purchasing and measurement phases. In Planning, performance modeling techniques, such as impression calculation and estimation, are applied to anticipated program goals, and, in conjunction with conventional ROI tools and with sponsorship asset planning, used to arrive at program plans. In purchasing, RFPs for sponsorship rights are managed, and, with data mining, program requirement filters and effective reach ROI estimates, used to purchase optimized events and rights. In measurement, feedback is obtained by comparing planning estimates to program actual performance, program ROI measurement, and program goals, in conjunction with appropriate MROI program controls.

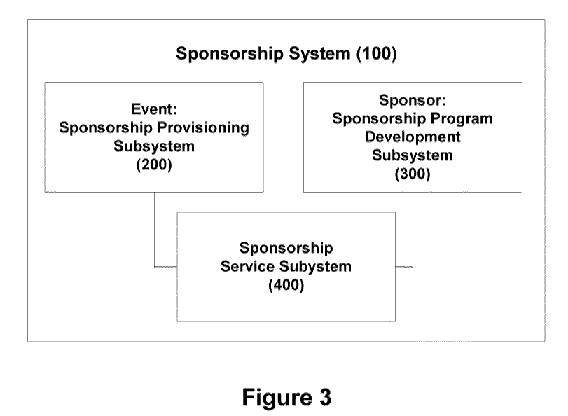

Sponsorship System 100 illustrated in FIG. 3 allows event producers and sponsors to interact with one another through an automated platform for sourcing and selling of sponsorship assets for cash and in-kind trade. FIG. 3 shows the sponsorship system which includes Event Sponsorship Provisioning Subsystem 200, Sponsor Sponsorship Program Development Subsystem 300, and Sponsorship Service Subsystem 400, operably connected to each other to exchange information necessary for the sale, exchange and sourcing of sponsorship programs.

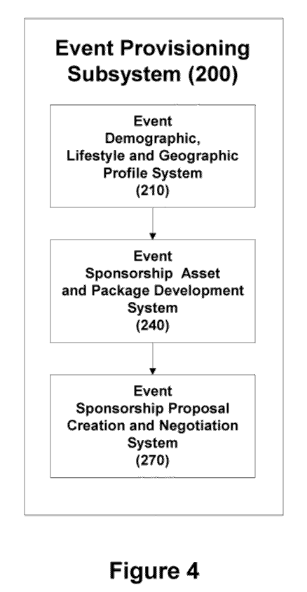

Event Provisioning Subsystem 200, as illustrated in FIG. 4, provides processes and systems for: Event Demographic, Lifestyle and Geographic Profile System 210, which provides processes for an event producer to specify a profile of an event including geographic, lifestyle and demographic information; Event Sponsorship Asset and Package Development System 240, which provides processes for an event producer to define the available event sponsorship assets and to organize those assets into possible sponsorship packages; and Event Sponsorship Proposal Creation and Negotiation System 270 which provides programmatic negotiation check off processes and means to convert a completed check list to contract language and a finished contract document. Subsystem 200 also provides processes for an event producer to post sponsorship packages for sale, to receive notification of a sponsor's sponsorship requirements, to input sales opportunities, to manage event sponsorship inventory, to propose sponsorship packages in response to Sponsor sponsorship requirements and to negotiate the terms of the sale of sponsorship assets and packages. The components of subsystems 210, 240 and 270 will be discussed below.

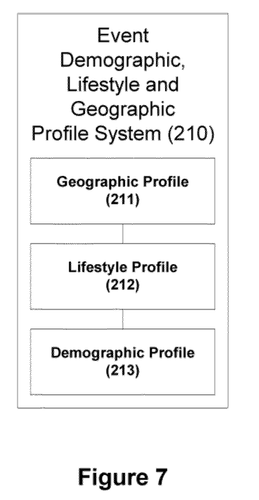

Event Demographic, Lifestyle and Geographic Profile System 210, as illustrated in FIG. 7, provides a process for inputting and storing at least a Geographic Profile 211, a Lifestyle Profile 212 and a Demographic Profile 213. Event Demographic, Lifestyle and Geographic Profile System 210 provides systems for event producers to input their Geographic Profile 211, Lifestyle Profile 212 information and Demographic Profile 213 information.

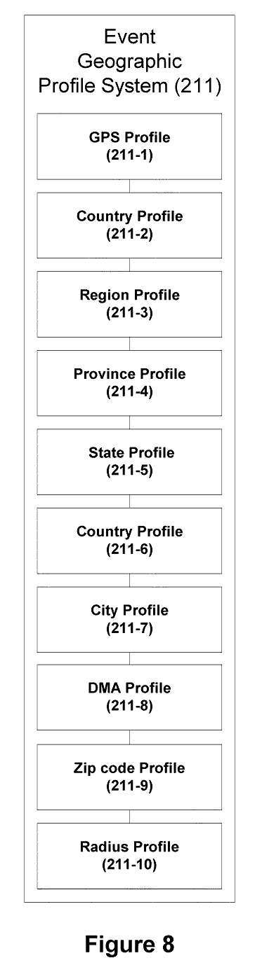

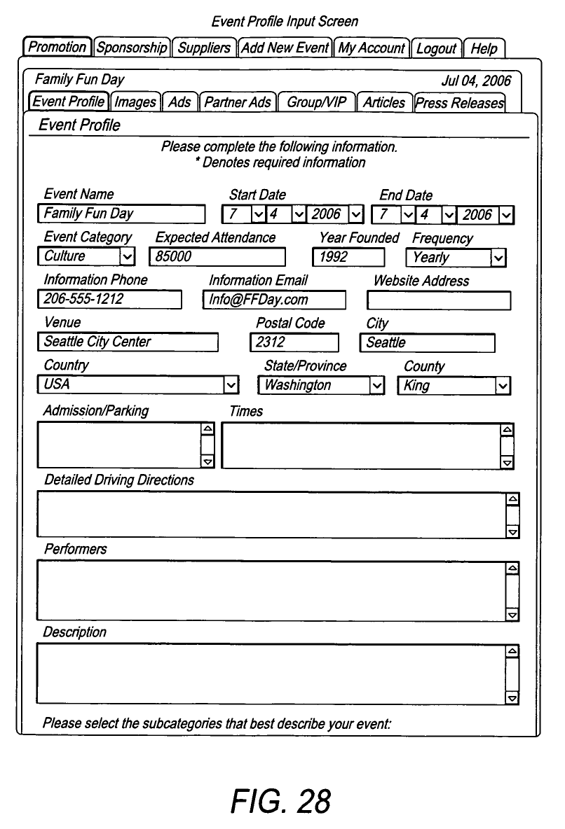

Event Geographic Profile System 211, as illustrated in FIG. 8, includes a GPS Profile 211-1, a Country Profile 211-2, a Region Profile 211-3, a Province Profile 211-4, a State Profile 211-5, a Country Profile 211-6, a City Profile 211-7, a DMA Profile 211-8, a Zip Code Profile 211-9 and a Radius Profile 211-10. One embodiment of system 211 is illustrated in FIG. 28. FIG. 28 is a screenshot of an Event Profile input screen, presented on web site 20, where an event producer inputs geographic and lifestyle profile information.

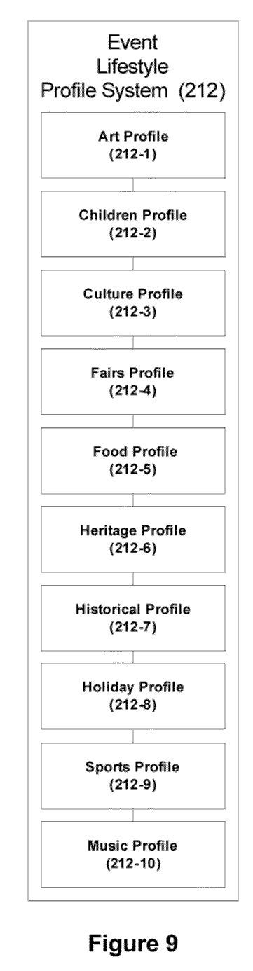

Event Lifestyle Profile System 212, as illustrated in FIG. 9, includes an Art Profile 212-1, a Children Profile 212-2, a Culture Profile 212-3, a Fairs Profile 212-4, a Food Profile 212-5, a Heritage Profile 212-6, a Historical Profile 212-7, a Holiday Profile 212-8, a Sports Profile 212-9 and a Music Profile 212-10. The Event Lifestyle Profile System 212 includes but is not limited to information in categories identified in FIG. 9 and the purpose is to accept data from producers which characterize their event and which are used to place the event in one or more classes for the purposes of matching it to sponsors event class preferences.

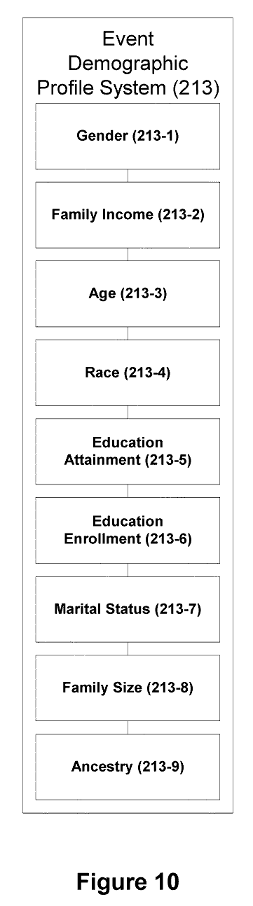

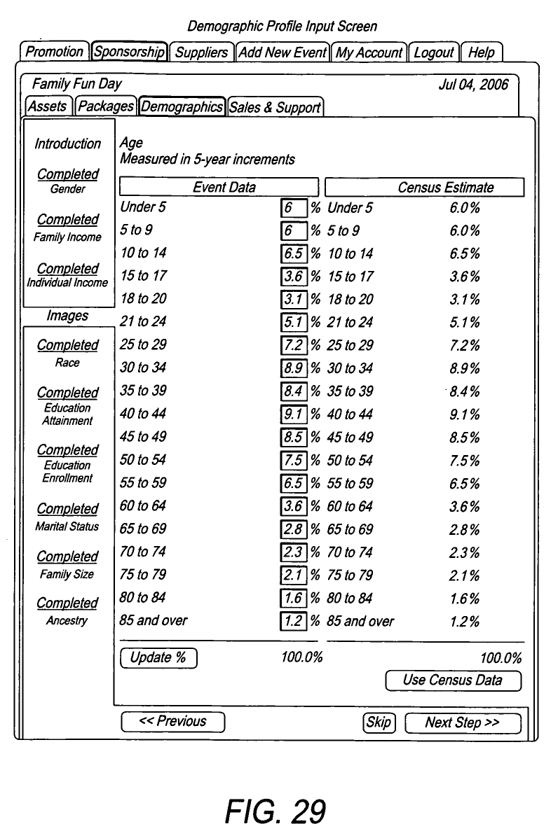

Event Demographic Profile System 213, as illustrated in FIG. 10, includes a Gender Profile 213-1, a Family Income Profile 213-2, an Age Profile 213-3, a Race Profile 213-4, an Education Attainment Profile 213-5, an Education Enrollment Profile 213-6, a Marital Status Profile 213-7, a Family Size Profile 213-8 and an Ancestry Profile 213-9. Within Demographic Profile System 213, event producers enter demographic data for their event through web site 20. FIG. 29, a Demographic Profile input screen, is an example of an input screen for such data. In the embodiment of FIG. 29, the event producer, by clicking the Use Census Data button, is able to see and/or use Census Bureau demographic data for the county in which the event is located based on the ZIP code information provided for the event's geographic location. The system also provides the user with a printable survey form and instructions for obtaining information from attendees to improve the accuracy of the demographic information about the event's attendees.

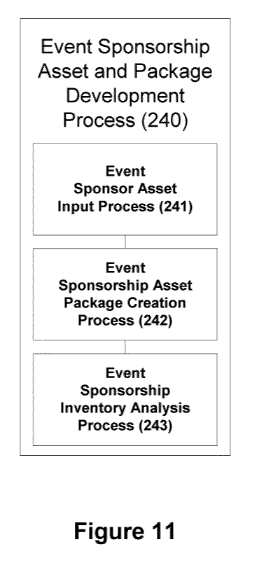

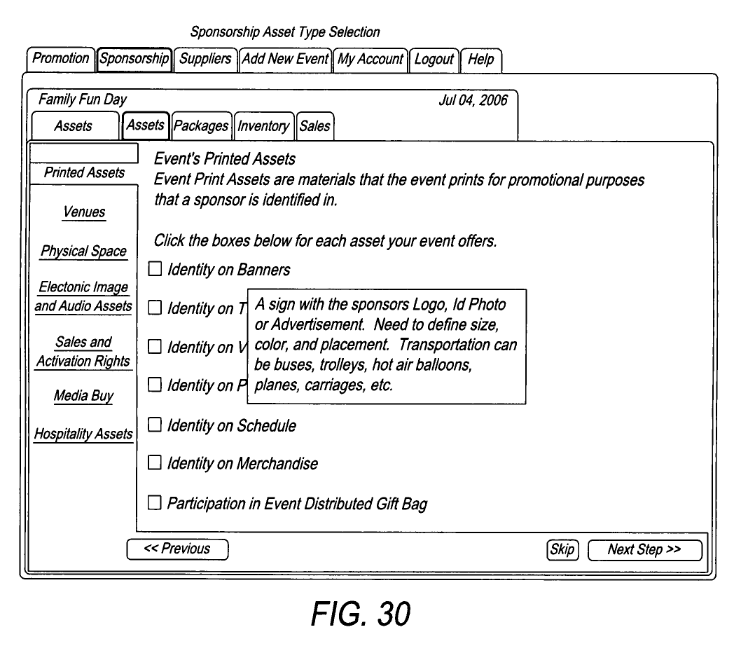

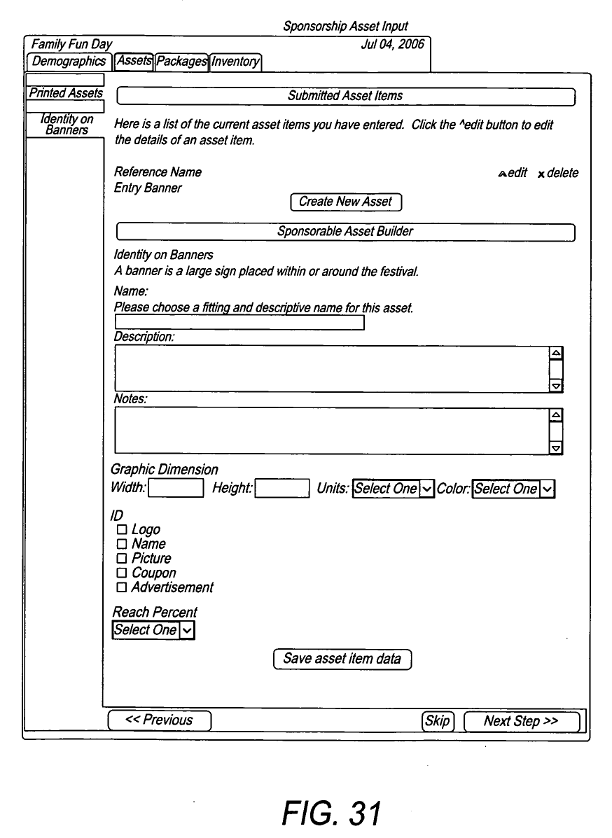

Event Sponsorship Asset and Package Development Process 240, as illustrated in FIG. 11, includes Event Sponsor Asset Input Process 241, Event Sponsor Asset Package Creation Process 242 and Event Sponsorship Inventory Analysis Process 243. Event Sponsor Asset Input Process 241 is a method for selecting available sponsorship assets. FIG. 30, a Sponsorship Asset Type Selection screen on web site 20, is an example of an input screen for such data. In the embodiment of FIG. 30, sponsors select specific asset types from within classes of assets. For example, within the asset class of printed assets, sponsors select identity on banners and identity on the event schedule. FIG. 31, a Sponsorship Asset input screen, is an example of an input screen for creating lists of specific assets within a class, including the ability to input details about each asset within that class.

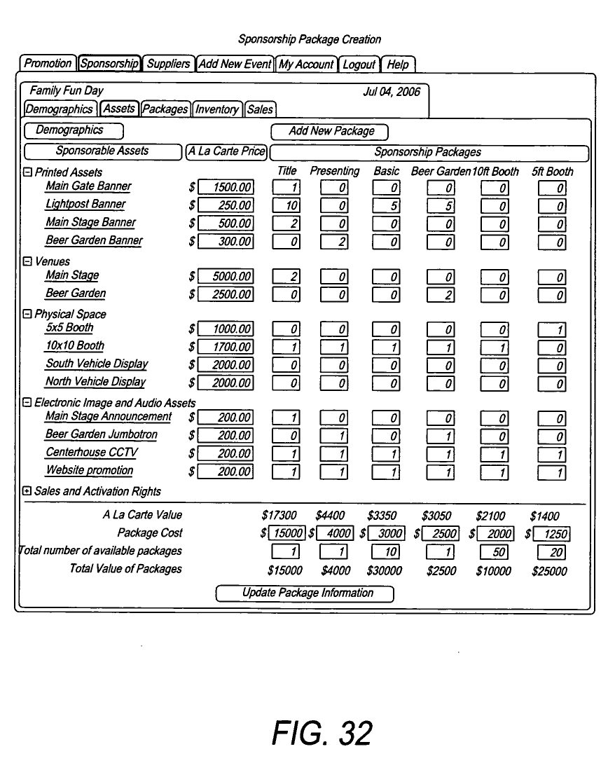

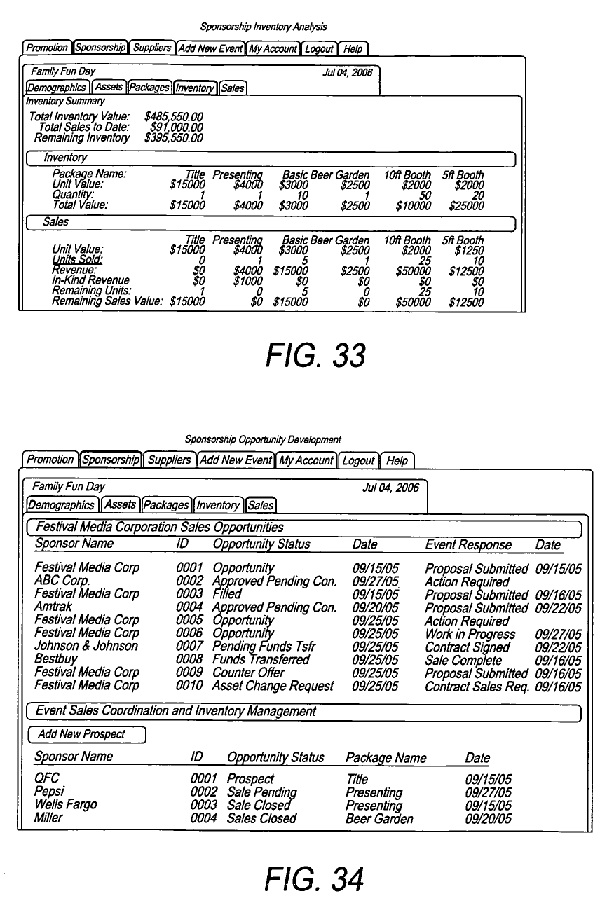

Event Sponsor Asset Package Creation Process 242 provides the event producer with the ability to organize individual assets into packages. As exemplified by the screenshot of FIG. 32, a Sponsorship Package Creation screen from web site 20, the event producer can input prices for each of the assets and each named package, create packages of assets by adding unit quantities of the individual assets that have been specified in process 241, price the named packages and define quantities of each type of package. Event Sponsorship Inventory Analysis Process 243 displays the total value of the inventory input through process 242. As exemplified in FIG. 33, a Sponsorship Inventory Analysis screen on web site 20, process 243 also presents detailed inventory information and sales information for sponsorship packages that have already been sold.

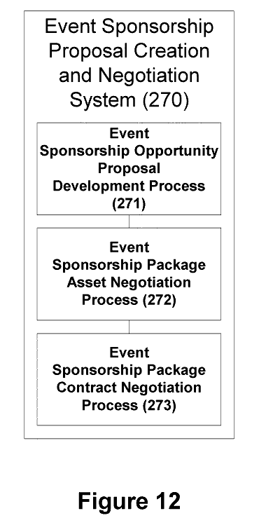

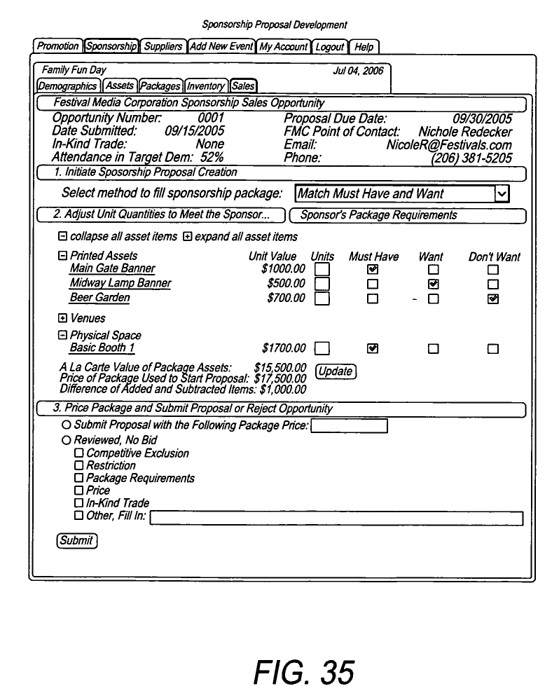

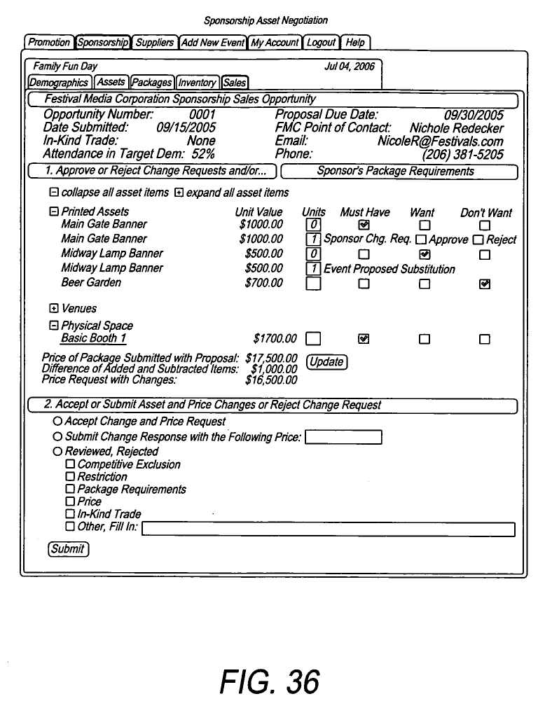

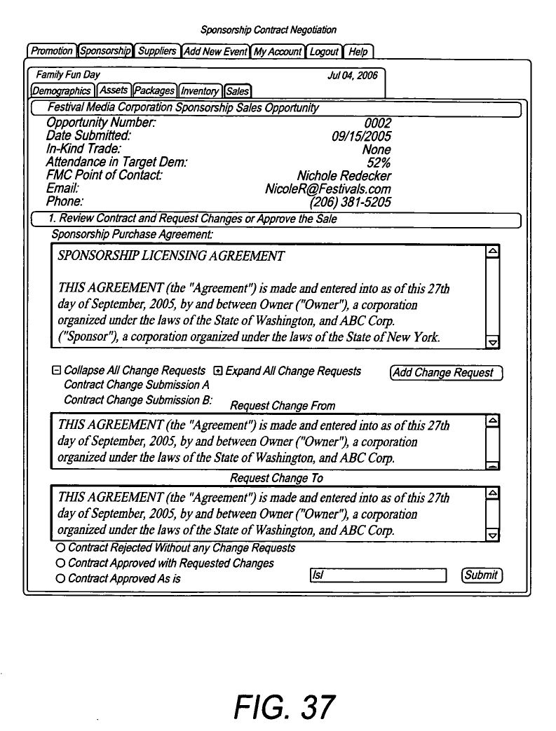

Event Sponsorship Proposal Creation and Negotiation System 270, as illustrated in FIG. 12, includes Event Sponsorship Opportunity Proposal Development Process 271, Event Sponsorship Package Asset Negotiation Process 272 and Event Sponsorship Package Contract Negotiation Process 273. Event Sponsorship Opportunity Proposal Development Process 271 allows an event producer to input sales opportunities through an “Add New Prospect” feature, and receive notification's of Sponsor requirements as exemplified by the screenshot of FIG. 34, a Sponsorship Opportunity Development Screen on web site 20. Process 270 also incorporates Event Sponsorship Package Asset Negotiation Process 272 as exemplified by the screenshot of FIG. 35, a Sponsorship Proposal Development screen from web site 20. The interactive screen illustrated in FIG. 35 allows the event producer to evaluate the percentage of attendees at their event which meet the sponsor's requirements, to see the sponsor's sponsorship asset requirements, to construct a sponsorship proposal by matching the event's assets with sponsor requirements, to populate the proposal with assets previously organized into packages, and adjust asset values and sponsorship package price. Process 272 also provides the event producer the ability to reject an opportunity. Additionally, process 272 in connection with process 271, process 372 and process 480 provides the event producer the ability to negotiate adjustments to the sponsorship package asset contents, the sponsorship package price and in-kind trade as exemplified by the screenshot of FIG. 36, a sponsorship Asset Negotiation screen from web site 10. Further, process 270 incorporates Event Sponsorship Package Contract Negotiation Process 273 that allows the event producer to negotiate the specific terms and conditions of a proposed purchase agreement for the sponsorship package as exemplified by the screenshot of FIG. 37, a Sponsorship Contract Negotiation screen from web site 20.

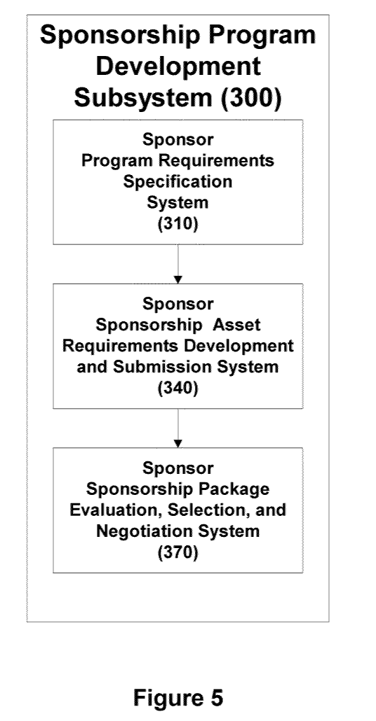

Sponsorship Program Development Subsystem 300, as illustrated in FIG. 5, includes Sponsor Program Requirements Specification System 310, Sponsor Sponsorship Asset Requirements Development and Submission System 340 and Sponsor Sponsorship Package Evaluation, Selection and Negotiation System 370. The subsystem 300 provides a method and set of processes that allow sponsors to create sponsorship programs, to specify the requirements for those programs, to map those requirements to sponsorable assets, to transmit those requirements to events, to receive and evaluate sponsorship package proposals and to negotiate and purchase sponsorship packages. The components of subsystems 310, 340 and 370 will be discussed below.

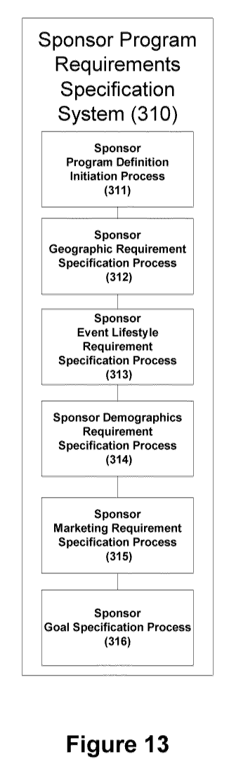

Sponsor Program Requirements Specification System 310, illustrated in FIG. 13, provides a process for inputting and storing at least a Sponsor Program Definition Initiation Process 311, Sponsor Geographic Requirement Specification Process 312, Sponsor Event Lifestyle Requirement Specification Process 313, Sponsor Demographics Requirement Specification Process 314, Sponsor Marketing Requirements Specification Process 315 and Sponsor Goal Specification Process 316.

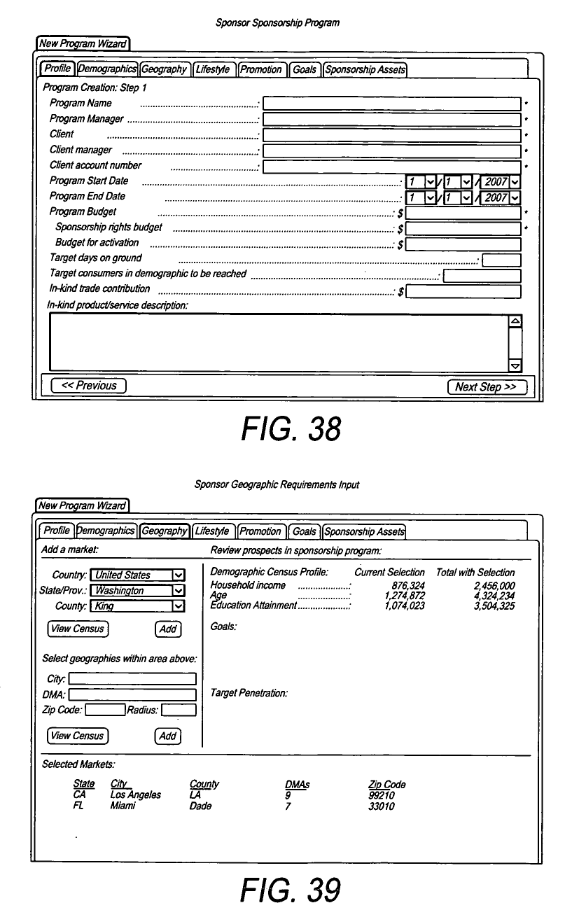

Sponsor Program Definition Initiation Process 311 as exemplified by the screenshot of FIG. 38, a Sponsor Sponsorship Program input screen from website 20, provides sponsors with a method of initiating a sponsorship program and initiating the creation of program requirements.

Sponsor Geographic Requirement Specification Process 312 as exemplified by the screenshot in FIG. 39, a sponsor Geographic Requirements input screen, provides sponsors with a method of evaluating and establishing the geographic target location requirements for the sponsorship program. Advantageously, if the sponsor has input demographic requirements through process 314, process 312 provides census information about the population within the sponsor's target demographic for a selected geography. The sponsor optionally evaluates the percentage of the population within a given geography that fits within the sponsor's target demographic by manipulating a set of variables including but not limited to country, state, province, county, city, broadcast DMA, zip code and a predefined geographic radius. As desired, the Sponsor may add selected geographies to the sponsor's sponsorship program requirements.

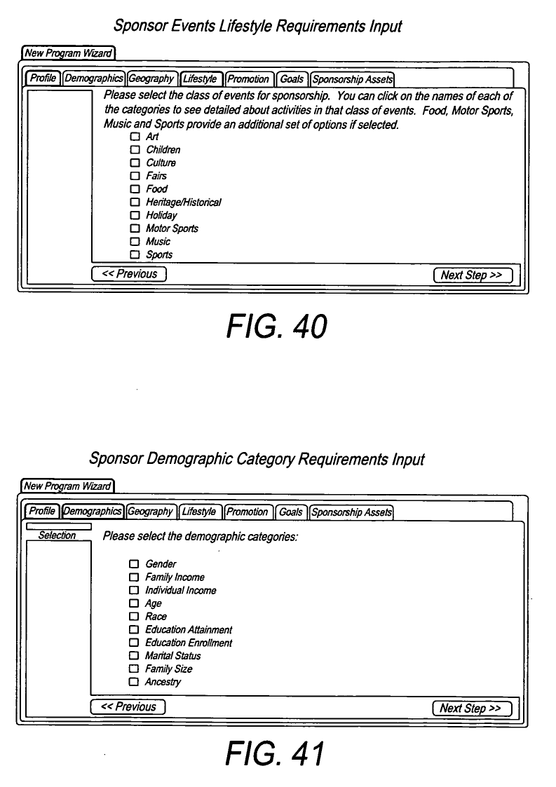

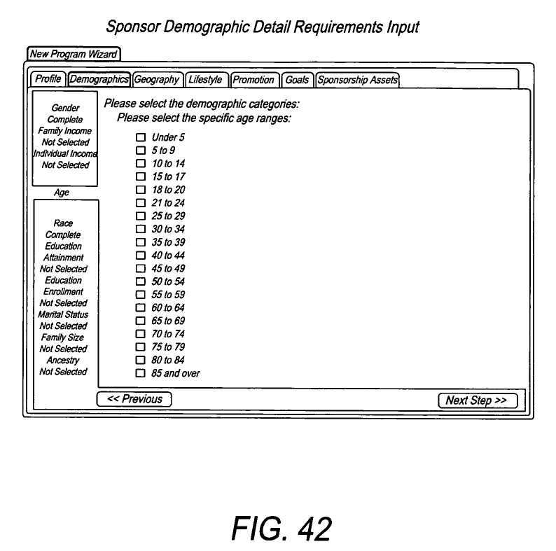

Sponsor Event Lifestyle Requirement Specification Process 313 allows sponsors to specify required classes of events according to lifestyle categories. One embodiment of an input means is illustrated in FIG. 40, a Sponsor Event Lifestyle Requirements input screen on web site 20. Lifestyle categories are not limited to those contained in FIG. 40.

Sponsor Demographic Requirement Specification Process 314, provides a method for selecting demographic criteria for the sponsorship program including but not limited to those demographic criteria exemplified in FIG. 41, a screenshot of a Sponsor Demographic Category Requirements input screen on web site 20. Further, once the sponsor has selected the primary demographic categories the sponsor wishes to incorporate into the sponsor's specification, the sponsor may further define the requirements for each category as exemplified in FIG. 40, a screenshot of a Sponsor Demographic Detail Requirements input screen on web site 20.

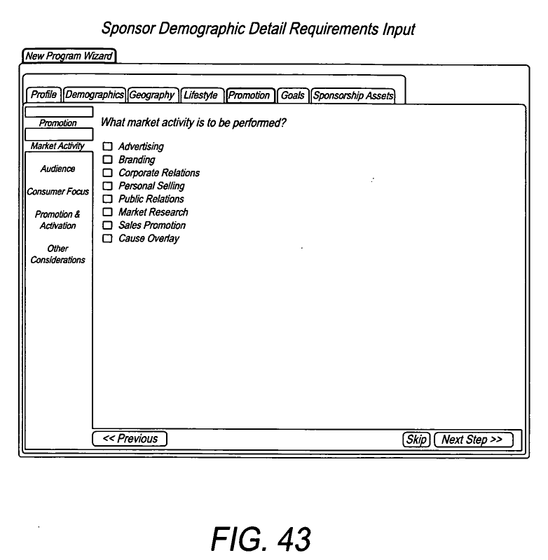

Sponsor Marketing Requirement Specification Process 315, as exemplified in FIG. 43, a screenshot of a Sponsor Marketing Requirements Specification input screen on web site 20, provides a set of selections for marketing activities a sponsor desires. The marketing program requirements categories include, but are not limited to, advertising, branding, corporate relations, personal selling, public relations, market research, sales promotion, and cause overlay. Optionally, in some embodiments sponsors input requirements for market activity audience, consumer focus, promotion inactivation, and other considerations.

Sponsor Goal Specification Process 316 provides a method for the sponsor to document their program goals.

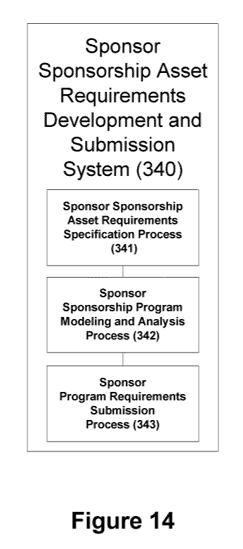

Sponsor Sponsorship Asset Requirements Development and Submission System 340, as illustrated in FIG. 14, includes Sponsor Sponsorship Program Modeling and Analysis Process 341, Sponsor Sponsorship Asset Requirements Specification Process 342 and Sponsor Program Requirements Submission Process 343. Sponsor Sponsorship Asset Requirements Development and Submission Subsystem 340 provides a set of processes for modeling the viability of a sponsor's un-submitted program, specifying the desired specific sponsorship assets required for the sponsor's sponsorship program and submitting the program for broadcast distribution to qualified events and event producers as determined by the sponsor service subsystem 400.

Sponsor Sponsorship Asset Requirements Specification Process 341 provides a method for defining the sponsorable assets required for the sponsor's sponsorship program. The sponsor may select sponsorable assets individually, and may also receive recommendations from the Marketing Program Asset Mapping Engine 460.

Sponsor Sponsorship Program Modeling and Analysis Process 342 provides the sponsor a process and method to assess the value of the sponsorship program in terms of total impressions, consumer reach and impression frequency as calculated by the combination of a sponsorship budget provided through process 311, Sponsor Geographic Requirements Specification Process 312 wherein the sponsor determines that geography required to provide adequate reach within the sponsor's target demographic, Sponsor Sponsorship Assets Requirements Specification Process 341 and the results of the Impression Calculation Engine 470 which takes input from process 341.

Sponsor Program Requirements Submission Process 343 provides a method and process for transmitting sponsor program requirements to the Sponsorship Service Subsystem 400.

Sponsor Package Evaluation, and Negotiation System 370, as illustrated in FIG. 15, includes Sponsor Package Recommendation and Review Process 371, Sponsor Sponsorship Package Asset Negotiation Process 372 and Sponsor Contract Negotiation Process 373. Sponsor Package Evaluation, and Negotiation System 370 provides a method for receiving sponsorship package recommendations, for reviewing sponsorship package recommendations, for approving sponsorship packages for purchase, for negotiating sponsorship package assets and for negotiating sponsorship contracts.

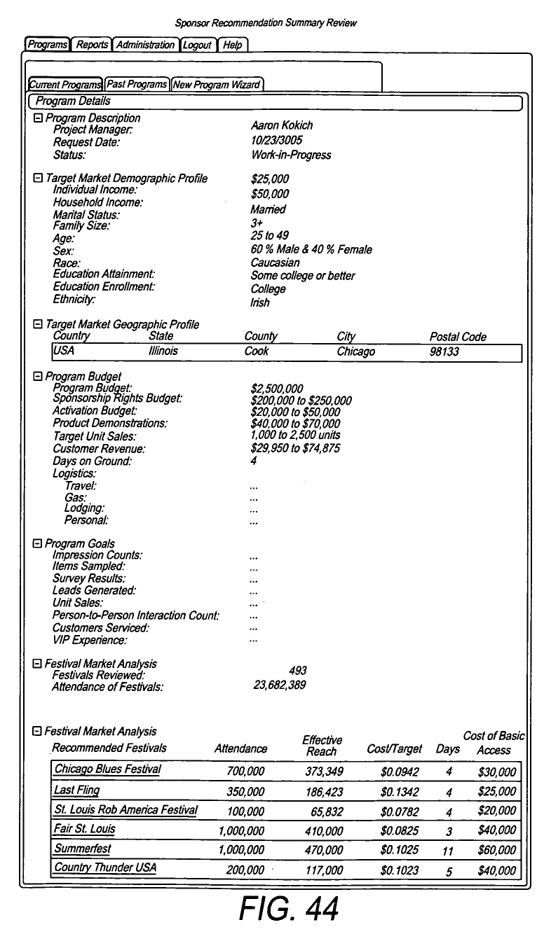

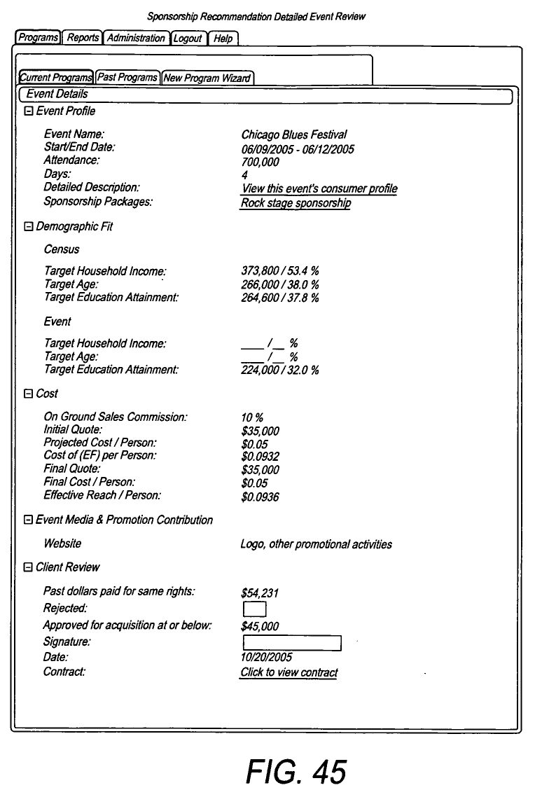

Sponsor Package Recommendation and Review Process 371 provides a process for evaluating the sponsorship program requirements and resulting recommendations as exemplified in FIG. 44, a screenshot of an example Recommendation Summary Review Screen from web site 20. Process 371 also provides a method and process for evaluating the details of each event recommendation as exemplified by FIG. 45, a screen shot of an example recommendation Detailed Event Review Screen.

Sponsor Sponsorship Package Asset Negotiation Process 372, provides a process for negotiating the contents of sponsorship packages proposed by an event as exemplified in FIG. 36, a Sponsorship Asset Negotiation screen on web site 10. Process 372 provides the sponsor the opportunity to modify the proposed in-kind trade, the individual sponsorship package assets, and the sponsorship package price.

Sponsor Contract Negotiation Process 373, provides a process whereby the sponsor can negotiate the specific terms and conditions for purchasing a proposed sponsorship package as exemplified in FIG. 37, a Contract Negotiation screen from web site 10. As assets are agreed upon through the methods illustrated in FIGS. 33 and 34, contract text is generated and can be reviewed through an interactive web page such as that illustrated in FIG. 37. Optimally, contract language can still be edited in the web page illustrated in FIG. 37. Advantageously, once the contract is satisfactory for both parties, the contract can be submitted and printed for signatures.

An Integrated Sponsorship Service System 400 provides a process for matching Sponsors geographic, lifestyle and demographic program requirements with sponsorship assets and packages of events, for optimizing event selection based on demographic reach, for identifying events willing to barter sponsorship packages for broadcast television program support, for mapping sponsorship assets to marketing program requirements, for calculating projected impressions for pending sponsorship programs, for calculating impressions from proposed event sponsorship packages, for receiving sponsorship package recommendations, for negotiating sponsorship packages and assets, for negotiating sponsorship package contracts and for communications and broadcasting between processes, sponsors and events. The Integrated Sponsorship Service System 400 includes Geographic Matching System 410, Lifestyle Matching System 420, Demographic Matching System 430, Demographic Reach Optimization Engine 440, Sponsorship Package Broadcast TV Program Barter System 450, Marketing Program Asset Mapping Engine 460, Impression Calculation Engine 470, Sponsorship Asset Recommendation, Negotiation and Contract System 480 and Sponsor Program Requirements Broadcast System 490.

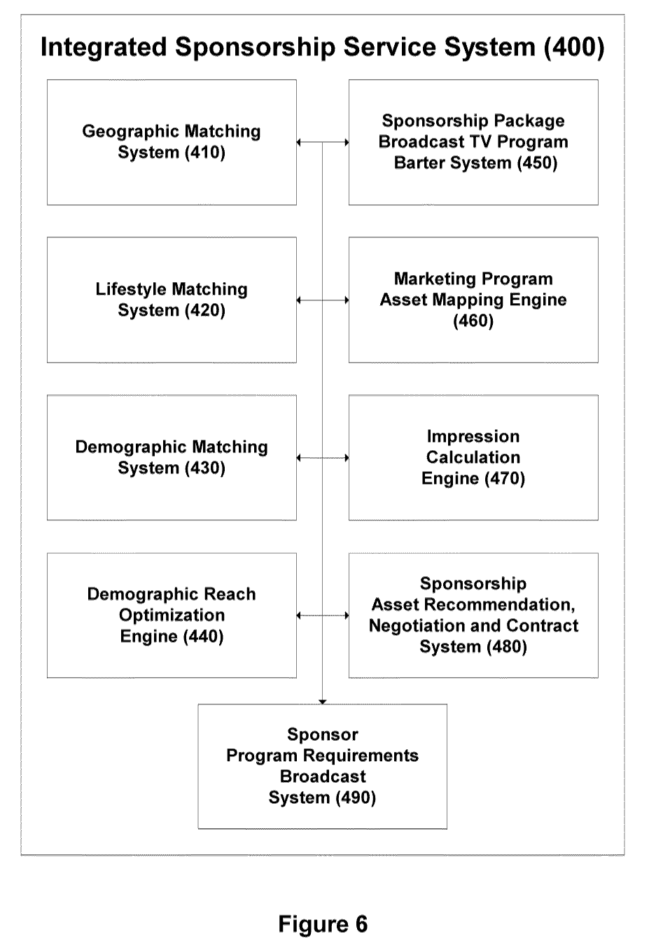

An Integrated Sponsorship Service System 400, as illustrated in FIG. 6, is the interactive optimization structure that embodies the multiple processes for matching and optimizing data entered by event producers for event assets and packages with data entered by event sponsors for their sponsorship requirements. System 400 embodies the following subsystems which will be discussed below: a Geographic Matching System 410, a Lifestyle Matching System 420, a Demographic Matching System 430, a Demographic Reach Optimization Engine 440, Sponsorship Package Broadcast TV Program Barter System 450, a Marketing Program Asset Mapping Engine 460, a Impression Calculation Engine 470, Sponsorship Asset Recommendation, Negotiation and Contract System 480 and Sponsor Program Requirements Broadcast System 490. Systems 410, 420, 430, 440, 450, 460, and 470 individually map, match, calculate or optimize data in order to produce asset and package recommendations. The systems are integrated in such a way that data produced by one system can be used in the processing of another system. The package recommendations which are produced are communicated through Sponsor Program Requirements Broadcast System 490. Packages are recommended, negotiated and result in contracts within Sponsorship Asset Recommendation, Negotiation and Contract System 480. Systems 410, 420, 430, 440, 450, 460, 470, 480 and 490 are discussed further below.

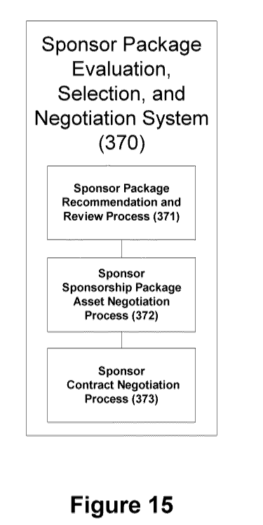

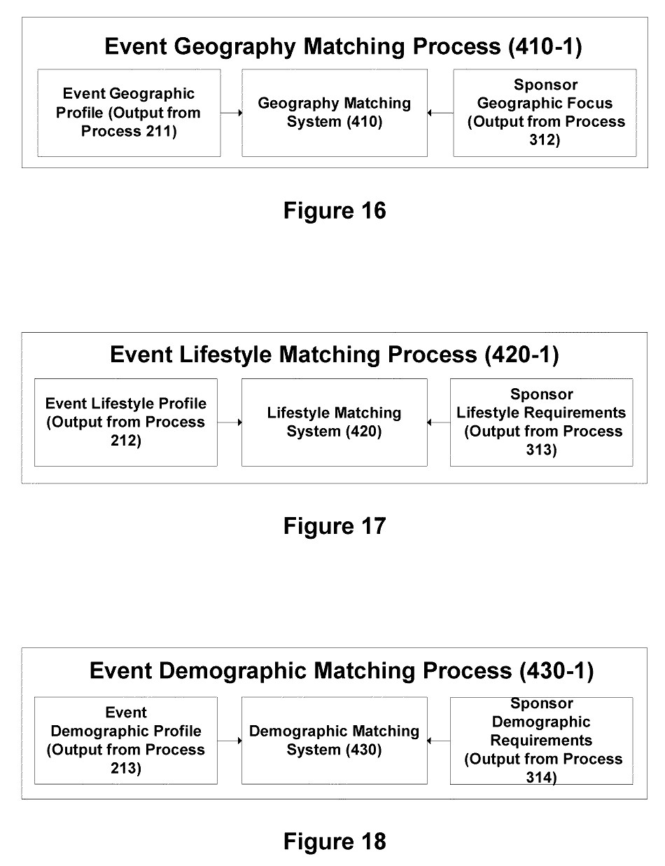

Event Geography Matching Process 410-1 as exemplified in FIG. 16, provides a process through a Geographic Matching System 410 for matching a sponsor's geographic requirements by taking input from Sponsor Geographic Requirement Specification 312 and matching it with input from Event Geographic Profile 211. Results are used by Demographic Reach Optimization Process 440-1.

Event Lifestyle Matching Process 420-1, as exemplified in FIG. 17, provides a process whereby a Lifestyle Matching System 420 takes input from Sponsor Lifestyle Requirements 313 and Events Lifestyle Profile 212 and outputs events that match Sponsors requirements for input to a Demographic Reach Optimization Process 440-1.

Event Demographic Matching Process 430-1, as exemplified in FIG. 18, provides a method and process whereby a Demographic Matching System 430 receives input from Sponsor Demographic Requirements Process 314 and Event Demographic Profile Processes 213 to identify target events that match Sponsor's requirements.

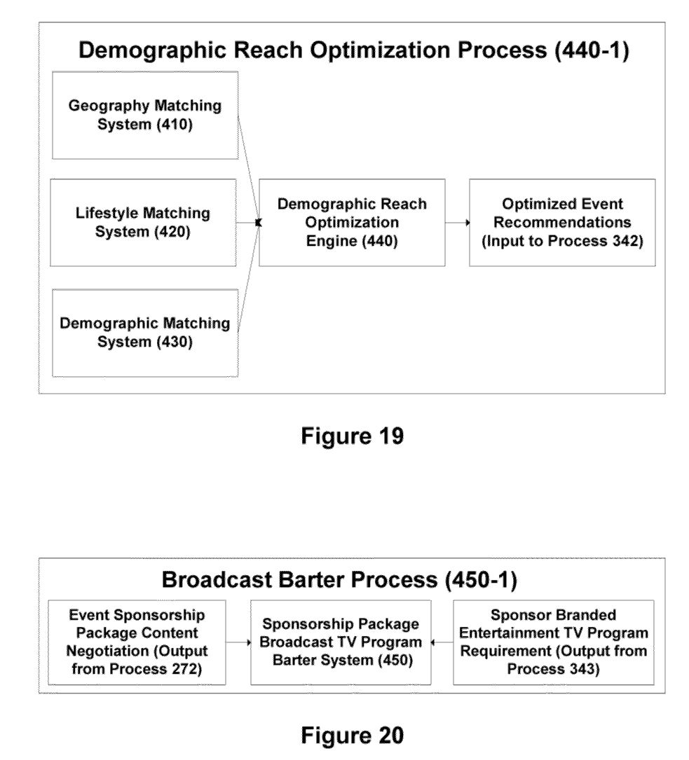

Demographic Reach Optimization Process 440-1, as exemplified in FIG. 19, provides a method and process of taking input from a Geography Matching System 410, a Lifestyle Matching System 420 and a Demographic Matching System 430 and applies that information to a Demographic Reach Optimization Engine 440 that identifies events with the highest percentage of attendees within the sponsor's target demographic and provides that information to the Optimized Event Recommendation Process 342. The result of this process optimizes the sponsors return on sponsorship investment.

Broadcast Barter Process 450-1, as exemplified in FIG. 20, provides a process for exchanging event sponsorship assets for sponsor funded branded entertainment television programs. Sponsorship Package Broadcast TV Program Barter System 450 receives input from Event Sponsorship Package Content Negotiation 272 and Sponsor Branded Entertainment TV Program Requirement 343 and produces barter program recommendations.

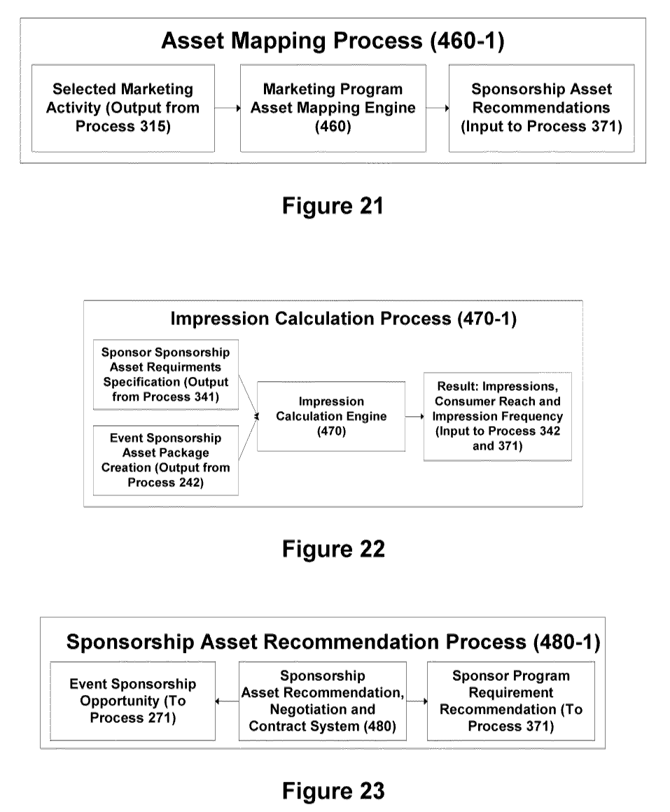

Asset Mapping Process 460-1 as exemplified in FIG. 21, incorporates a Marketing Program Asset Mapping Engine 460 that provides sponsorship asset recommendations based on input from Selected Marketing Activity 315, and outputs sponsorship asset recommendations to Sponsorship Asset Recommendations 371.

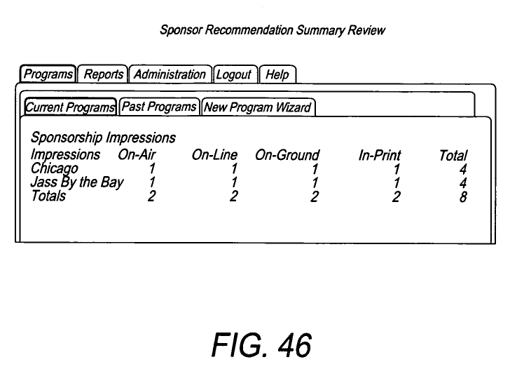

Impression Calculation Process 470-1 as seen in FIG. 22, includes a Impression Calculation Engine 470 and takes input from Event Sponsor Asset Package Creation 242 and Sponsor Sponsorship Asset Requirements Specification 342. This information provides the sponsor with impression data and estimated return on sponsorship investment information, as exemplified in FIG. 45, and provides categorized impressions as exemplified in FIG. 46.

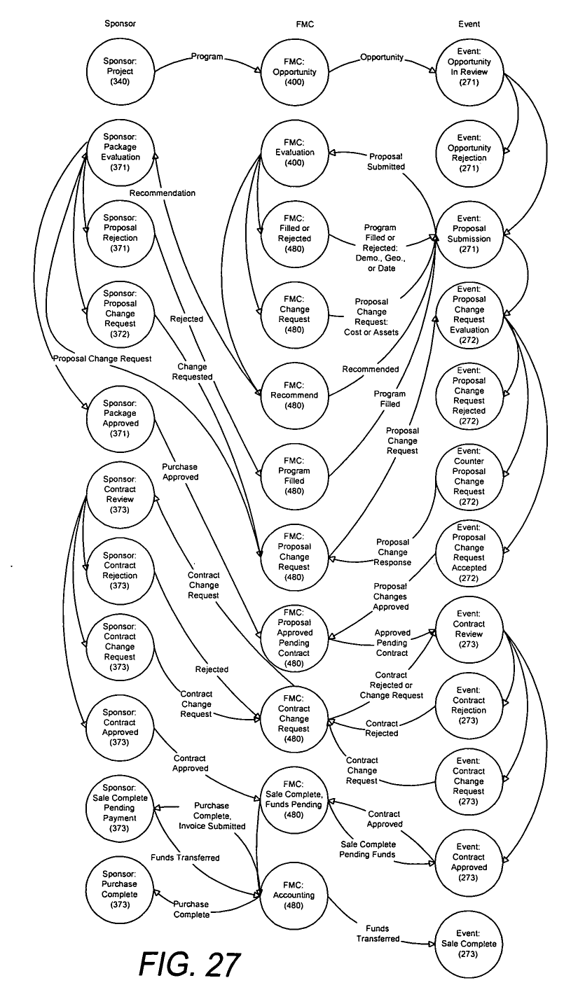

Sponsorship Asset Recommendation Process 480-1, as exemplified in FIG. 23, incorporates Sponsorship Asset Recommendation, Negotiation and Contract System 480 which communicates with Event Sponsorship Opportunity 271 and Sponsor Program Requirement Recommendation 371 through a Requirements Broadcast System 490 and utilizes but is not limited to the Sponsorship Sourcing State Machine, as illustrated in FIG. 27, to facilitate sponsorship asset and package recommendations.

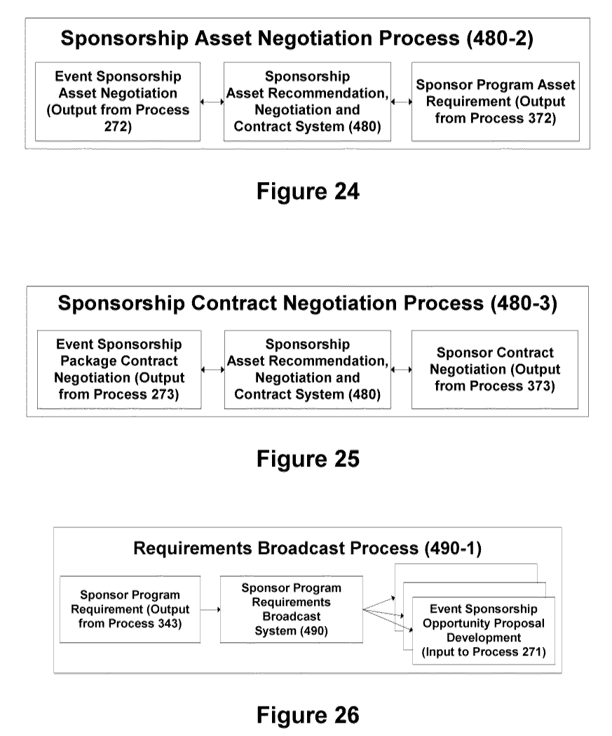

Sponsorship Asset Negotiation Process 480-2, as exemplified in FIG. 24, incorporates Sponsorship Asset Recommendation, Negotiation and Contract System 480 which communicates with Event Sponsorship Asset Negotiation 272, and Sponsor Program Asset Requirement 372 through a Requirements Broadcast System 490 and utilizes but is not limited to the Sponsorship Sourcing State Machine, as exemplified in FIG. 27, to facilitate sponsorship package and asset negotiations.

Event Sponsorship Contract Negotiation Process 480-3 as exemplified in FIG. 25, incorporates Sponsorship Asset Recommendation, Negotiation and Contract System 480 which communicates with Event Sponsorship Contract Negotiation 273 and Sponsor Contract Negotiation 373 through Requirements Broadcast System 490 and utilizes but is not limited to, the Sponsorship Sourcing State Machine, as exemplified in FIG. 27, to facilitate the sale and purchase of sponsorship packages between sponsors and events.

A Requirements Broadcast Process 490-1, as seen in FIG. 26, includes Sponsor Program Requirements Broadcast System 490 that receives information from Sponsor Program Requirements Process 343 and outputs information to Event Sponsorship Opportunity Proposal Development Process 271.

The Sponsorship Sourcing State Machine, seen in FIG. 27, defines states and consequent processes that are invokeable by the System and its users once sponsor requirements have been submitted to the Sponsorship Service Subsystem 400.

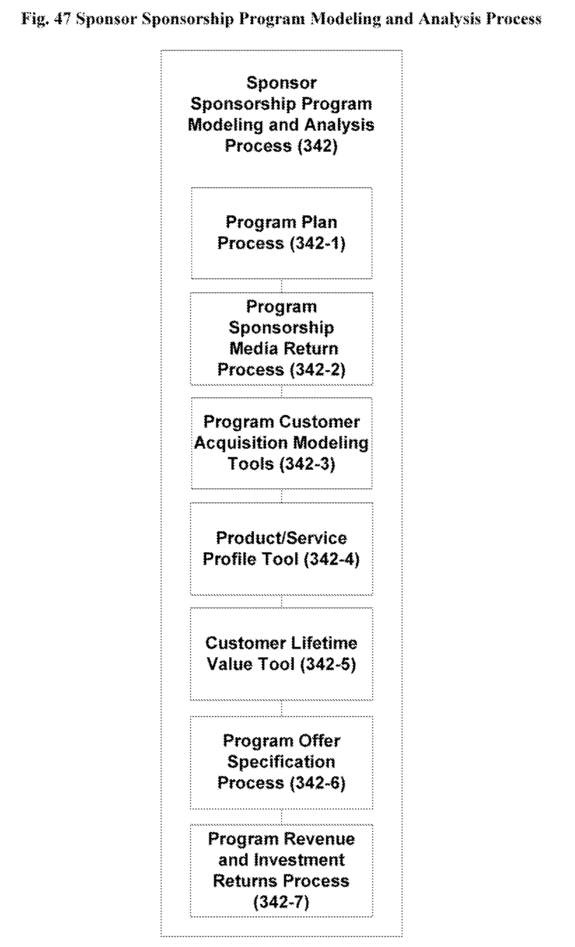

Additional modules disclose the workings of augmented processes, such as the Sponsors Sponsorship Program Modeling and Analysis Process (342) seen in FIG. 47. This process includes seven sub processes (342 1-7) which allow the user to model the potential media impressions, customer acquisitions and return on investment for a event based marketing program.

The Program Plan process (342-1) accepts input from the user including the cost of capital, from the Sponsor Program Definition Initiation Process (311) and from the Demographic Reach Optimization System (430).

The Program Sponsorship Media Return Process (342-2) takes input from the user including effective reach of attendance and Media ROI, from the Demographic Reach Optimization Engine (440), the Sponsor Goal Specification Process (316) and the Impression Calculation Engine Process (470).

The Program Customer Acquisition Modeling Tools (342-3) takes input from the user, including adoption rates for the programs and influencer impact and from the Sponsor Goal Specification Process (316), the Program Sponsorship Media Return Process (342-2) and the Demographic Reach Optimization System (430).

The Product/Service Profile Tool (342-4) takes input from the Takes input from a user including product and service information, pricing and distribution channel discount information.

The Customer Lifetime Value Tool (342-5) takes input from user including the customer purchase profiles, and the customer lifetime period, and from Product/Service Profile Tool (342-4).

The Program Offer Specification Process (342-6) takes input from the user, including product/services and consumer and distribution channel discounts.

The Program Revenue and Investment Return Process (342-7) Program Plan Process (342-1), the Program Sponsorship Media Return Process (342-2), the Program Customer Acquisition Modeling Tool, (342-3), the Customer Lifetime Value Tool (342-5), and the Program Offer Specification Process (342-6), and receives calculations from the Sponsor Program Return On Investment Modeling and Measurement System (495) which are delivered to the user.

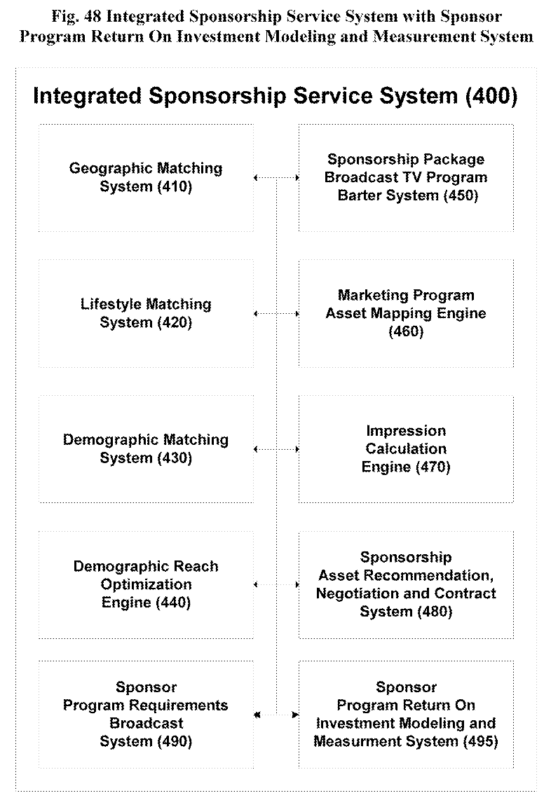

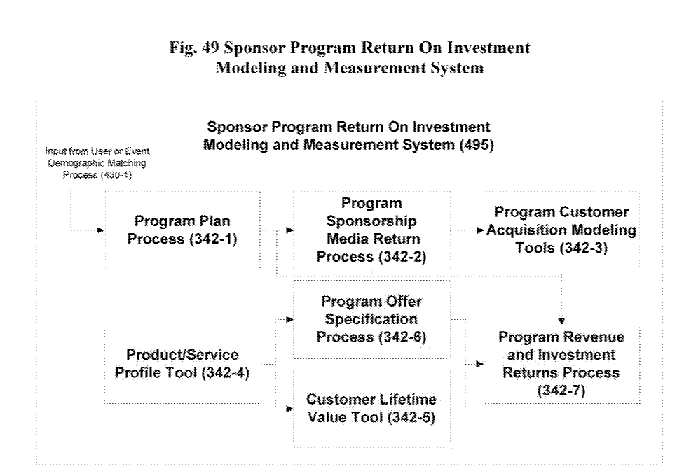

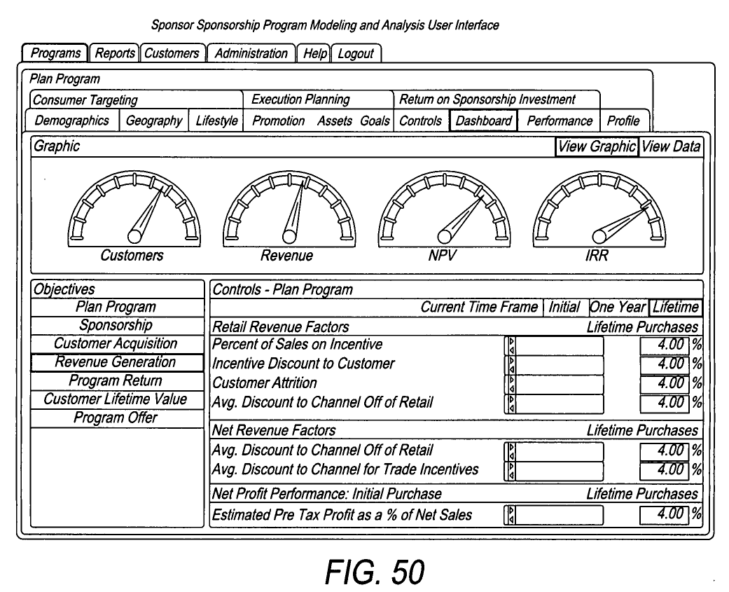

The Sponsor Program Return On Investment Modeling and Measurement System (495) in FIG. 48 accepts inputs from Processes 342-1 through 342-7 (see FIG. 49) and calculates values that are delivered from those Processes. A user interface design for these processes is provided in FIG. 50.

Preferred embodiments of all or part of this automated process are optionally implemented on computing machines having computer readable memory, and interconnected with other such computing machines over computer networks, such as the Internet.

### INDUSTRIAL APPLICABILITY

The disclosed system and method uniquely provides an automated system that matches event assets with sponsor requirements, identifies events that meet the sponsors' geographic, demographic, psycho-graphic and budgetary requirements, determines the impressions and consumer reach available with a given set of sponsorship assets and packages, and facilitates efficient contract negotiations. In addition, the disclosed system and method provides an automated system that allows sponsors to rank potential assets and produces television program recommendations.

In compliance with the statute, the invention has been described in language more or less specific as to structural features. It is to be understood, however, that the invention is not limited to the specific features illustrated, since the means and construction illustrated comprise preferred forms of putting the invention into effect. The invention is, therefore, claimed in any of its forms or modifications within the legitimate and valid scope of the appended claims, appropriately interpreted in accordance with the doctrine of equivalents.

I claim:

1. A system for sponsorship sourcing of events comprising:
a. at least one computer;
b. means for input to and output from computer readable storage media;
c. the at least one computer running a sponsorship sourcing application operatively configured to:
i. store data input from an event producer; and
ii. use the event producer's data input to programmatically create and store event asset data.

2. The system of claim 1 further comprising the data input from an event producer selected from the group of data consisting of asset types, asset descriptions, asset prices, asset locations, quantities of assets, asset dimensions, asset package elements and asset package prices.

3. A system for sponsorship sourcing of events comprising:
a. at least one computer;
b. means for input to and output from computer readable storage media;
c. the at least one computer running a sponsorship sourcing application operatively configured to:
i. store data input from an event sponsor; and
ii. use the event sponsor's data input to programmatically create and store sponsorship requirement data.

4. The system of claim 3 further comprising the data input from an event sponsor selected from the group of data consisting of customer profiles, demographics, geography, lifestyle, budget, marketing activity, asset types, asset ranking, number of impressions, consumer reach numbers, impression frequency and package requirements.

5. A system for sponsorship sourcing of events comprising:
a. at least one computer;
b. means for input to and output from computer readable storage media;
c. the at least one computer running a sponsorship sourcing application operatively configured to:
i. store data input from an event producer;
ii. use the event producer's data input to programmatically create and store event asset data;
iii. store data input from an event sponsor;
iv. use the event sponsor's data input to programmatically create and store sponsorship requirement data; and
v. match event asset data to sponsorship requirement data to programmatically create a sponsorship program.

6. The system of claim 5 wherein the sponsorship sourcing application is further operatively configured to:
i. store data input from data sources selected from the group of data sources consisting of census bureaus, geographic mapping sources, tax bureaus and city planning offices; and
ii. analyze and combine data input to programmatically create and store data pertinent to event sponsorship.

7. The system of claim 5 wherein the sponsorship sourcing application further comprises a demographic reach optimization engine operatively configured to produce event recommendations.

8. The system of claim 5 wherein the sponsorship sourcing application further comprises a television program barter engine operatively configured to produce television program recommendations.

9. The system of claim 5 wherein the sponsorship sourcing application further comprises an asset mapping engine operatively configured to produce sponsorship asset recommendations.

10. The system of claim 5 wherein the sponsorship sourcing application further comprises an impression calculation engine operatively configured to produce predictions selected from the group of predictions consisting of numbers of impressions, durations of impressions, consumer reach figures, impression frequency figures, cost per impression and return on investment figures.

11. The system of claim 5 wherein the sponsorship sourcing application is further operatively configured to:
i. store negotiation data input from producers and sponsors;
ii. analyze negotiation data, calculate and store negotiation calculations; and
iii. output negotiation data to producers and sponsors.

12. The system of claim 11 wherein the negotiation data is selected from the group of negotiation data consisting of asset assignments to sponsorship packages, unit quantities and pricing, sponsor change requests, producer proposed substitutions, proposals, proposal acceptance and proposal rejection.

13. The system of claim 11 wherein the sponsorship sourcing application is further operatively configured to track negotiation input and create and output reports of negotiation progress.

14. The system of claim 13 wherein the reports comprise reports to event producers of the sales process on each package for each sponsor.

15. The system of claim 13 wherein the reports comprise reports to sponsors of negotiation data for all events selected from the group of negotiation data for all events consisting of assets proposed, assets purchased, asset type and total cost distribution.

16. The system of claim 11 wherein the sponsorship sourcing application is further operatively configured to create sponsorship contract documents during the negotiation process and output the contract documents at the close of negotiations.

17. A system for sponsorship sourcing of events comprising:
a. at least one computer;
b. means for input to and output from computer readable storage media;
c. the at least one computer running a sponsorship sourcing application operatively configured to:
i. store data input from an event producer;
ii. use the event producer's data input to programmatically create and store event asset data;
iii. store data input from an event sponsor;
iv. use the event sponsor's data input to programmatically create and store sponsorship requirement data;
v. match event asset data to sponsorship requirement data to programmatically create a sponsorship program;
vi. store data input from data sources selected from the group of data sources consisting of census bureaus, geographic mapping sources, tax bureaus and city planning offices;
vii. analyze and combine data input to programmatically create and store data pertinent to event sponsorship;
viii. produce event recommendations through a demographic reach optimization engine;
ix. produce television program recommendations through a television program barter engine;
x. produce sponsorship asset recommendations through an asset mapping engine; and
xi. produce predictions selected from the group of predictions consisting of numbers of impressions, durations of impressions, consumer reach figures, impression frequency figures, cost per impression and return on investment figures through an impression calculation engine.

18. The system of claim 17 wherein the sponsorship sourcing application is further operatively configured to:
i. store negotiation data input from producers and sponsors;
ii. analyze negotiation data, calculate and store negotiation calculations;
iii. output negotiation data to producers and sponsors;
iv. track negotiation input and create and output reports of negotiation progress; and
v. create sponsorship contract documents during the negotiation process and output the contract documents at the close of negotiations.

19. A system for sponsorship sourcing of events comprising:
a. at least one computer operating as a server on a distributed network;
b. at least one computer operating as a client to the server on a distributed network;
c. means for input to and output from computer readable storage media residing on the at least one server computer;
d. the at least one server computer hosting a website;
e. the at least one client computer running a browser application for accessing the website;
f. the at least one server running a sponsorship sourcing application operatively configured to:
i. store data input from an event producer;
ii. use the event producer's data input to programmatically create and store event asset data;
iii. store data input from an event sponsor;
iv. use the event sponsor's data input to programmatically create and store sponsorship requirement data; and
v. match event asset data to sponsorship requirement data to programmatically create a sponsorship program.

20. The system of claim 19 wherein the sponsorship sourcing application is further operatively configured to:
i. produce event recommendations through a demographic reach optimization engine;
ii. produce television program recommendations through a television program barter engine;
iii. produce sponsorship asset recommendations through an asset mapping engine;
iv. produce predictions selected from the group of predictions consisting of numbers of impressions, durations of impressions, consumer reach figures, impression frequency figures, cost per impression and return on investment figures through an impression calculation engine;
v. store negotiation data input from producers and sponsors;
vi. analyze negotiation data, calculate and store negotiation calculations;
vii. output negotiation data to producers and sponsors;
viii. track negotiation input and create and output reports of negotiation progress; and
ix. create sponsorship contract documents during the negotiation process and output the contract documents at the close of negotiations.
